(19) United States
(12) Patent Application Publication
(10) Pub. No.: US 2017/0080861 A1
(43) Pub. Date: Mar. 23, 2017

(54) VEHICLE SENSOR SYSTEM AND METHOD OF USE

(71) Applicant: Pearl Automation Inc., Scotts Valley, CA (US)

(72) Inventors: Saket Vora, Scotts Valley, CA (US); Brian Sander, Scotts Valley, CA (US); Joseph Fisher, Scotts Valley, CA (US); Bryson Gardner, Scotts Valley, CA (US); Tyler Mincey, Scotts Valley, CA (US); John Brock, Scotts Valley, CA (US); Keith Hendren, Scotts Valley, CA (US); Waylon Chen, Scotts Valley, CA (US); Rishabh Bhargava, Scotts Valley, CA (US); Patrick Carroll, Scotts Valley, CA (US)

(21) Appl. No.: 15/259,543

(22) Filed: Sep. 8, 2016

Related U.S. Application Data
(60) Provisional application No. 62/215,582, filed on Sep. 8, 2015.
(60) Provisional application No. 62/351,847, filed on Jun. 17, 2016.

(51) Int. Cl. B60R 1/00; H04N 5/225

(52) U.S. Cl. CPC B60R 1/00; H04N 5/2252; B60R 2300/103; B60R 2300/406

(57) ABSTRACT

A vehicle retrofit system for a vehicle having a license plate, the vehicle retrofit system including a sensor module with: a casing, a set of sensors, a communication system, a power system, and a sensor module retention mechanism.

### CROSS-REFERENCE TO RELATED APPLICATIONS

This application claims the benefit of U.S. Provisional Application No. 62/215,582 filed 8 Sep. 2015 and U.S. Provisional Application No. 62/351,847 filed 17 Jun. 2016, which are incorporated in their entireties by this reference. This application is related to U.S. application Ser. No. 15/146,705 filed 4 May 2016, which claims priority to U.S. Provisional Application No. 62/156,411 filed 4 May 2015 and U.S. Provisional Application No. 62/215,578 filed 8 Sep. 2015, which are incorporated in their entireties by this reference.

### TECHNICAL FIELD

This invention relates generally to the automotive field, and more specifically to a new and useful vehicle sensor system in the automotive field.

### BRIEF DESCRIPTION OF THE FIGURES

FIGS. 1A and 1B are a front elevation view and an isometric view of a variation of the vehicle sensor system, respectively.

FIG. 2 is a schematic representation of a variation of vehicle sensor system use.

FIG. 3 is an exploded view of a variation of the vehicle sensor system coupling to a vehicle.

FIG. 4 is an example of a variation of the vehicle sensor system mounted to a vehicle.

FIGS. 5A and 5B are schematic representations of the front and back of a variation of the vehicle sensor system, respectively, the variant including a main module region configured to retain a first and second image sensor, an energy harvester support region, and a cord storage groove.

FIG. 6 is an exploded view of the components of a variation of the vehicle sensor system.

FIG. 7 is a schematic representation of energy harvester connection with the remainder of the vehicle sensor system.

FIG. 8 is an exploded view of a variation of the antenna module.

FIG. 9 is an exploded view of assembled antenna module of FIG. 8 assembly into the casing of the vehicle sensor system.

FIGS. 10A and 10B are schematic representations of a universal connector removably coupling to a permanent power cable and a USB header, respectively.

FIG. 10C is a schematic representation of a variant of the removable USB header.

FIG. 11 is an example of a circuit for the vehicle sensor system.

FIGS. 12A, 12B, and 12C are examples of a variation of the vehicle sensor system: fully mounted to the backing plate, partially mounted to the backing plate, and removed from the backing plate, respectively.

FIGS. 13A and 13B are an assembled view of a hub variant and an exploded view of the hub variant, respectively.

FIG. 14 is an example of a circuit for the hub.

FIG. 15 is an example of waterproofing components for the vehicle sensor system.

FIG. 16 is an example of waterproofing components for the camera.

FIG. 17 is a schematic representation of an example of the vehicle bus state detector.

FIG. 18 is a schematic representation of an example of vehicle bus state detector operation.

FIG. 19 is a schematic representation of an example of the casing with a lens hood.

FIG. 20 is a schematic representation of an example of the casing with a sensor module retention mechanism.

FIG. 21 is a schematic representation of a side view of an example of the casing and the backing plate removably coupled.

FIG. 22 is a schematic representation of a bottom view of an example of the casing with a barrier member.

FIGS. 23A and 23B are an exploded view of a portion of an example sensor module and backing plate and a cross-sectional view of a portion of the example sensor module and backing plate, respectively.

FIGS. 24A and 24B are schematic representations of side views of a portion of an example of the sensor module partially inserted into the backing plate and fully inserted into the backing plate, respectively.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview of the System and Method of Use.

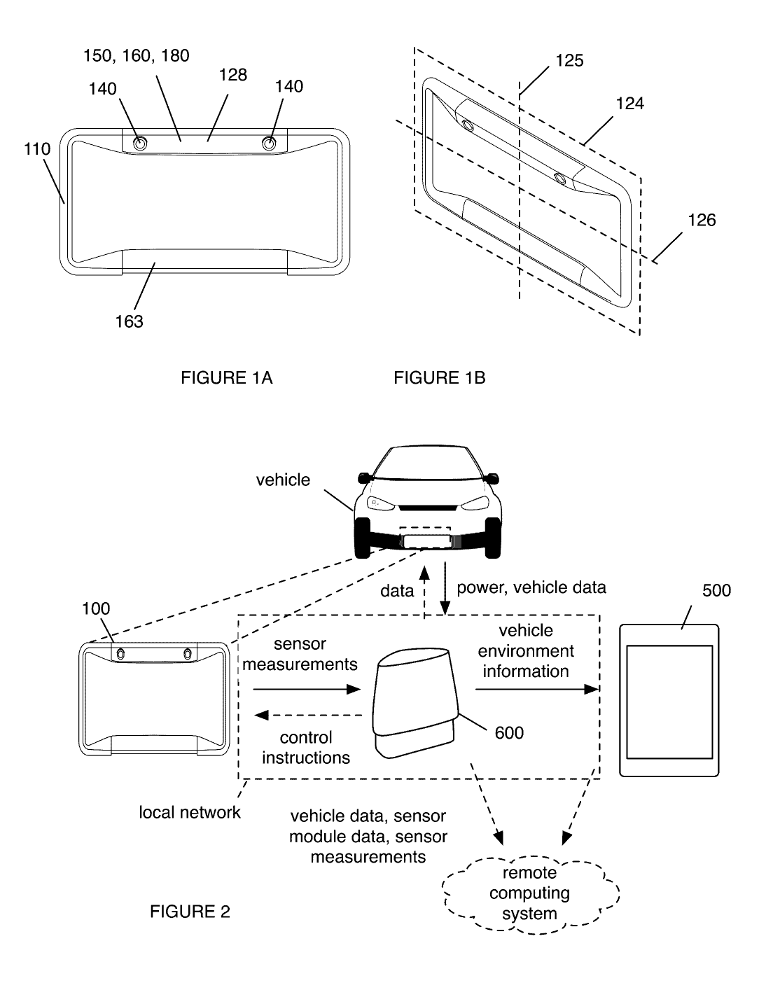

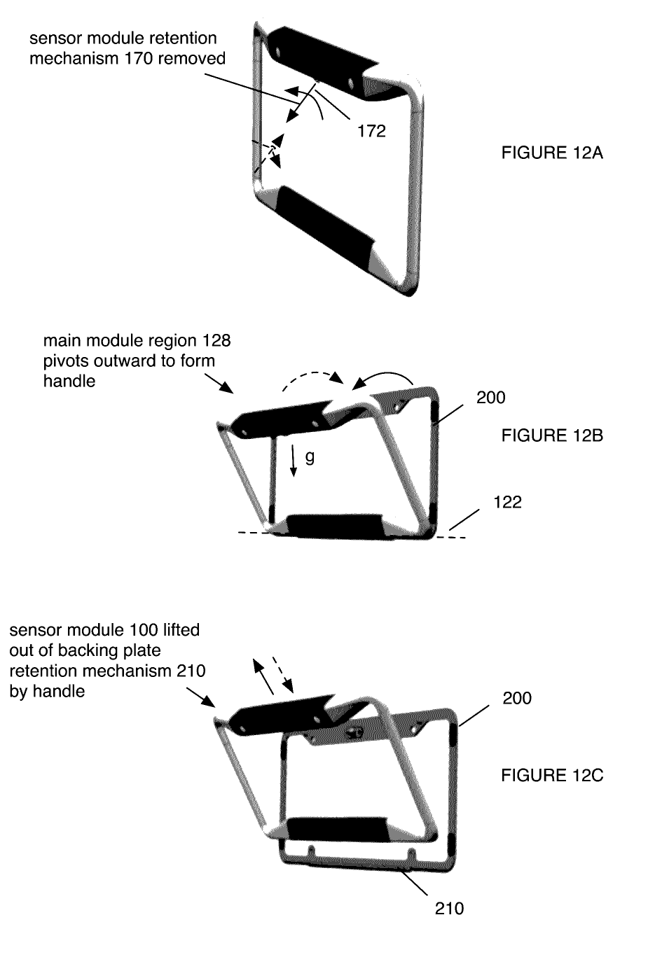

As shown in FIGS. 1A and 12A-12C, the vehicle sensor system 50 includes a sensor module 100. The sensor module 100 includes: a casing 110, a set of sensors, a communication system 150, a power system 160, and a sensor module retention mechanism 170. The vehicle sensor system 50 optionally includes a backing plate 200. The backing plate 200 can include a backing plate retention mechanism 210 that is removably couplable to the sensor module retention mechanism 170. The vehicle sensor system 50 can optionally include a hub 600. The vehicle sensor system 50 functions to equip a vehicle with sensors, and to provide the vehicle environment information to a user. The vehicle sensor system 50 can be used to retrofit the vehicle with sensors (e.g., add sensors to a manufactured vehicle), add sensors to the vehicle during manufacture, or otherwise equip the vehicle with sensors. For example, the vehicle sensor system 50 can function as a backup camera (example shown in FIG. 4), blind spot detector, tire pressure monitor, front collision sensor, or perform any other suitable functionality.

The vehicle sensor system 50 can add sensors to the vehicle rear (e.g., distal the steering system), vehicle fore (e.g., proximal the steering system), vehicle side(s), vehicle top, and/or vehicle bottom. In a first variation, as shown in FIG. 1A, the sensor module 100 and/or backing plate 200 of the vehicle sensor system 50 is a plate holder that removably or substantially permanently mounts to the vehicle bumper (e.g., the front or rear vehicle bumper). In a second variation, the sensor module 100 and/or backing plate 200 of the vehicle sensor system 50 is a side mirror or side mirror cover. In a third variation, the sensor module 100 and/or backing plate 200 of the vehicle sensor system 50 is a sticker configured to adhere to any vehicle surface. However, the vehicle sensor system 50 can have any other suitable form factor.

In a specific example of vehicle sensor system operation, as shown in FIG. 2, the sensor module 100 records sensor measurements indicative of the vehicle environment and sends the measurements to a vehicle hub 600. The vehicle hub 600 can process the measurements, generate information about the vehicle environment, and send the generated information to the user (e.g., to a user device 500). The generated information can be images, text, video, overlays, or be any other suitable graphical, audio, or tactile output. The information can be generated based on the measurements (e.g., raw or processed measurements), external data (e.g., weather, information from a social networking system account associated with the driver, etc.), or be generated based on any other suitable data. The measurements and/or information can be sent through an internal network (e.g., a local network generated by the hub 600, sensor module 100, other component of the vehicle sensor system 50, mobile device, vehicle), be sent through an external network (e.g., WiFi network established by a router external the car, cellular network, etc.), or be otherwise transmitted.

In the former variant, the component generating the internal network (e.g., hub 600, mobile device, sensor module 100) can be connected to a vehicle power system 160 (e.g., the vehicle accessory power system 160, engine, motor, batter, or other vehicle source of energy) through an accessory connector, OBD connector (e.g., OBD-II diagnostic connector), CAN connector, secondary connector, or other connector, or can be independently powered (e.g., using an on-board power source or energy harvesting system 163), or be otherwise powered. In one variation, the sensor module 100 can include both an automatic charging system (e.g., a solar charging system) and a manual charging system (e.g., a wired charging system), wherein the sensor module 100 can be automatically charged by the automatic charging system while mounted to the vehicle, and can be removed from the vehicle for manual charging (e.g., using a power source separate and/or distinct from the vehicle). The auxiliary systems connecting to the network (e.g., hub 600, mobile device, vehicle sensor system 50) can be individually powered (e.g., using a solar power system 160, kinetic energy conversion system, a battery, etc.), powered by the vehicle power system 160, wirelessly powered by the system generating the internal network, or be otherwise powered.

### 2. Benefits.

This system can confer several benefits over conventional vehicle sensor systems.

First, the sensor module 100 can be powered independently of the vehicle electrical system. This can resolve the issue of supplying power to the sensor module(s) 100, particularly when the sensor modules 100 are deployed along the exterior of the vehicle, where little to no electrical connections exist. In other words, this can enable already-manufactured vehicles to be easily retrofitted with the vehicle sensor system 50 (e.g., by reducing or eliminating physical sensor wiring to the vehicle electrical system). Some variants of the sensor module 100 accomplish this by including a power system 160 that includes a charging module within the sensor module 100 (e.g., a solar charging system, kinetic energy harvesting system 163, etc.) and a battery charged by the charging module, such that the battery can be charged and the set of sensors can be automatically powered. The power system 160 can optionally include an electrical connector that can be removably connected to an external power source (e.g., a power grid, external energy harvesting system, etc.), which enables the battery to be charged by the external power source. This can allow primary or supplemental charging of the battery through the electrical connector (e.g., when the charging module does not sufficiently charge the battery), which can further decouple and/or eliminate the sensor module's 100 dependence on the vehicle's electrical system. The sensor module 100 can optionally be easily removable from the vehicle (e.g., wherein the backing plate 200 remains attached to the vehicle while the sensor module 100 is removed from the backing plate 200). This sensor module 100 removability can allow charging of the battery through the electrical connector to occur away from the vehicle (e.g., distal the vehicle). For example, if the external power source is not accessible from the vehicle, the sensor module 100 can be removed and placed near and/or connected to the external power source to enable battery charging.

Second, by using the system with a hub 600 or other system that is continuously connected to vehicle power, the system can utilize less power by shifting power-intensive computing functions to the vehicle-powered system. The sensor module 100 can also use less power by using the vehicle-powered hub 600 as an intermediary communication channel. In this variant, the sensor module 100 can shift all long-range communication functionalities (e.g., communication with external devices) to the vehicle-connected hub 600, and simply communicate with the vehicle-connected hub 600 via a short-range communication protocol, which can require less power. The lowered system power consumption can decouple the sensor module 100 from reliance on vehicle power, which simplifies system installation (e.g., does not require a user to wire the power system 160 into the vehicle power system) and enables the system to be installed in more locations on the vehicle.

Third, variants of the system reduce part complexity (and cost) by leveraging the user device 500 as the user feedback system.

Fourth, in some variants (e.g., when the sensor module 100 and/or backing plate 200 is a license plate holder), the system mounts to pre-existing, standardized mounting points, which confers the benefits of simplifying installation and accommodating multiple vehicle makes and models.

Fifth, in some variants, by grounding some or all electrical components to the system housing (e.g., instead of the vehicle frame), the system can accommodate multiple vehicle makes and models, irrespective of the vehicle mounting surface material and/or the properties of vehicle features (e.g., vehicle shape, window shape and placement, sunroofs, etc.) that can affect system performance (e.g., network connection reliability, etc.).

Sixth, the set of sensors, communication system 150, power system 160, and/or any other components of the sensor module 100 can be arranged along the upper portion of the casing 110, wherein the casing 110 can be a license plate frame (example shown in FIGS. 12A, 12B, and 12C). This configuration confers the benefit of easy, intuitive removal in at least two ways. One, the top- and/or front-heavy arrangement of components offsets the sensor module's 100 center of mass toward the upper frame portion, such that the sensor module 100 automatically pivots along the lower frame portion away from the vehicle when the upper frame portion is released from the backing plate 200. This functions to expose a region of the frame for user gripping and handling. Alternatively, the frame bulge defined to accommodate the components arranged along the upper portion of the casing 110 can function as a handle or lever to pivot the upper portion of the casing 110 away from the vehicle. Two, the frame bulge functions as an ergonomic, intuitive handle for the user to lift the frame out of the backing plate 200.

Seventh, some variants can include dedicated hardware that performs certain processes (e.g., dewarping video, decoding video, etc.), instead of using software to perform these processes. By sacrificing future expansion, using purpose-built circuitry can increase the processing speed over software-based methods. However, the vehicle sensor system 50 can confer any other suitable benefit.

### 3. Vehicle Sensor System.

### 3.1 Sensor Module.

### 3.1.1 Casing.

The casing 110 of the sensor module 100 functions to mechanically protect and support the system components. The casing 110 defines a casing exterior 111 and a casing interior 112. The casing 110 can additionally function as electrical ground, function as an antenna 155, function as a heatsink, function as an EMI shield (e.g., include electromagnetic shielding), function as a mechanical shock dampener, function as a fluid-resistant shield (e.g., include a water-resistant enclosure), or perform any other suitable functionality. The casing 110 can be in the shape of a frame (e.g., a trace the form factor of a license plate holder), side mirror, disc, bumper, handle, or have any other suitable form factor. The casing 110 is preferably formed from metal (e.g., aluminum, steel, etc.), but can alternatively be made of plastic, ceramic, or from any other suitable material or combination thereof. Optionally, the casing 110 removably or permanently mounts to a backing plate 200.

The casing 110 can include arms 114, preferably including a first arm and a second arm opposing each other, each extending along an axis substantially parallel (e.g., within 1 degree of parallel, within 5 degrees of parallel) to a longitudinal axis 126 defined by the casing 110. Optionally, one or more of the arms 114 can be in the shape of a handle, preferably an ergonomic handle. Optionally, one or more of the arms 114 can enclose other components of the sensor module 100. The casing 110 can additionally include a third arm and a fourth arm, each preferably extending along an axis substantially parallel to a lateral axis 125 defined by the casing 110, wherein the lateral axis 125 is perpendicular to the longitudinal axis 126. The third and fourth arms can mechanically connect the first arm to the second arm. In one example, the first arm and the second arm each have a first end and a second end, wherein the third arm is connected to the first end of the first arm and the first end of the second arm and the fourth arm is connected to the second end of the first arm and the second end of the second arm, wherein the casing 110 defines a license plate frame, as shown in FIGS. 1A-1B. One or more of the arms 114 can be configured to provide protection (e.g., EMI shielding, fluid resistance, etc.). In a first specific example, an arm 114 (e.g., the first arm) can include electromagnetic shielding (e.g., be made of conductive material, include a conductive mesh, etc.). In a second specific example, an arm 114 (e.g., the first arm) can include a water-resistant enclosure (e.g., be made of water-impermeable material, include o-rings or gaskets along seam lines, etc.) surrounding a camera, a wireless communication module 152, and a battery.

The casing no can define a frontal plane 119 and a rear plane 120 parallel to the frontal plane 119. The frontal 119 and rear planes 120 can be parallel to a gravity vector (e.g., wherein the casing 110 is installed on a vehicle), parallel or normal to a component of the vehicle sensor system 50, parallel or normal to a component (e.g., a license plate, a body panel, an axle, a seat) of a vehicle on which the casing 110 is installed, or have any other suitable orientation. The frontal 119 and rear planes 120 are preferably defined with respect to a sensor module mating surface 118 or support region 121 (e.g., such that the sensor module 100 support region 121 extends between and terminates at the frontal 119 and rear planes 120, as shown in FIG. 21).

In one embodiment, the casing 110 has the profile of a frame (e.g., license plate frame) and defines a frame plane 124. In this embodiment, the frontal 119 and rear planes 120 are preferably substantially parallel (e.g., within 1 degree of parallel, within 5 degrees of parallel, etc.) to the frame plane 124, as shown in FIG. 1B. Alternately, the frontal 119 and rear planes 120 can have any suitable orientation with respect to the frame plane 124.

The casing 110 can include a main module region 128. The main module region 128 is preferably within one or more of the arms 114 of the housing, more preferably in an arm 114 opposing a sensor module mating surface 118, but alternatively can be any suitable region of the casing 110. The main module region 128 can contain one or more other components of the sensor module 100.

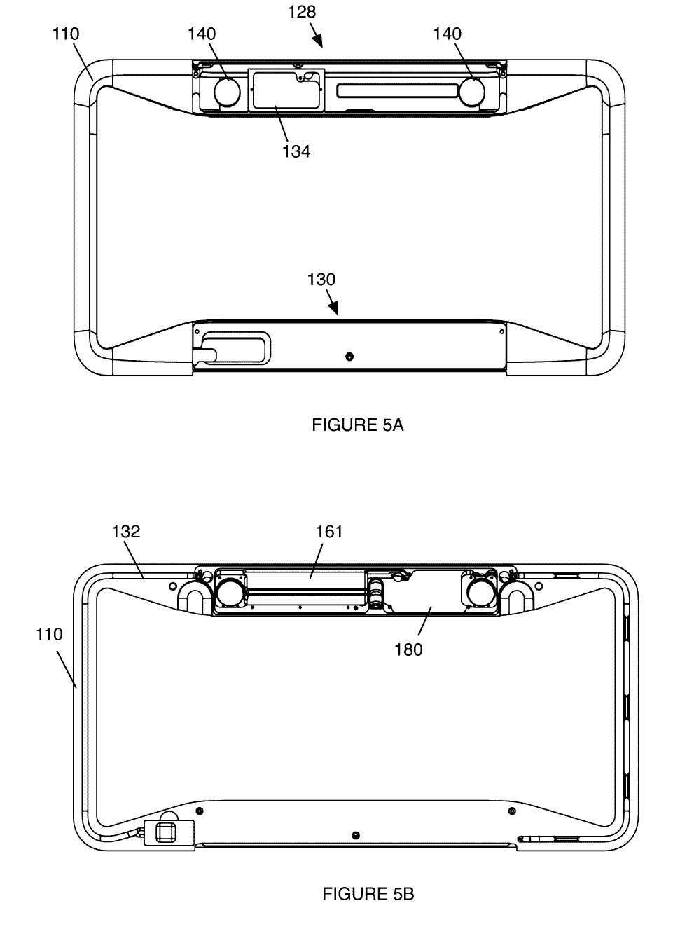

The frame can additionally define an energy harvester support region 130, as shown in FIG. 5A. The energy harvester support region 130 can be substantially flush with the frame plane 124, extend from the frame plane 124, be recessed relative to the frame plane 124, or be otherwise configured. The energy harvester support region 130 is preferably defined along the same face as the main module region 128, but can alternatively be defined along a different face. The energy harvester support region 130 preferably does not extend as far from the frame plane 124 as the main module region 128 (e.g., such that the main module region 128 overshadows the energy harvester support region 130), but can alternatively be substantially coplanar with the main module region 128 or extend further than the main module region 128. The energy harvester support region 130 can be substantially flat (e.g., parallel to the frame plane 124, tilted upward relative to the frame plane 124, etc.), curved, or have any suitable configuration. In one variation, the face shared by the energy harvester support region 130 and the main module region 128 is substantially smooth (e.g., does not include large elevation changes), but can alternatively include grooves, protrusions, or any other suitable feature. The energy harvester support region 130 can be defined in the lower portion, upper portion, lateral arm 115, or any other suitable portion of the frame.

In this example, the frame can additionally define a cord storage groove 132 configured to receive and transiently retain a cord, as shown in FIG. 5B. The cord can be a data transfer cord, power cord, or be any other suitable cord or wire. The cord storage groove 132 preferably traces all or a portion of the frame profile, but can alternatively extend along any portion of the frame. The cord storage groove 132 is preferably defined along the face of the frame opposing the energy harvester support region 130 and/or main module region 128, but can alternatively be defined in any other suitable location.

In this example, the frame can additionally define an antenna retention recess 134 that functions to retain the antenna module 154 of the communication system 150, as shown in FIGS. 5A and 9. The antenna retention recess 134 can be defined in the sensor support and/or energy harvester support region 130, the cord storage groove 132 face, or be defined in any other suitable location. The antenna retention recess 134 can additionally define a cable manifold that extends through the frame interior to a processing system retention region (defined on the same face or opposing face). The antenna retention recess 134 is preferably defined within the main module region 128, but can alternatively be defined within the energy harvester support region 130 or in any other suitable frame region. However, the casing 110 can have any other suitable configuration, and define any other suitable support regions 121.

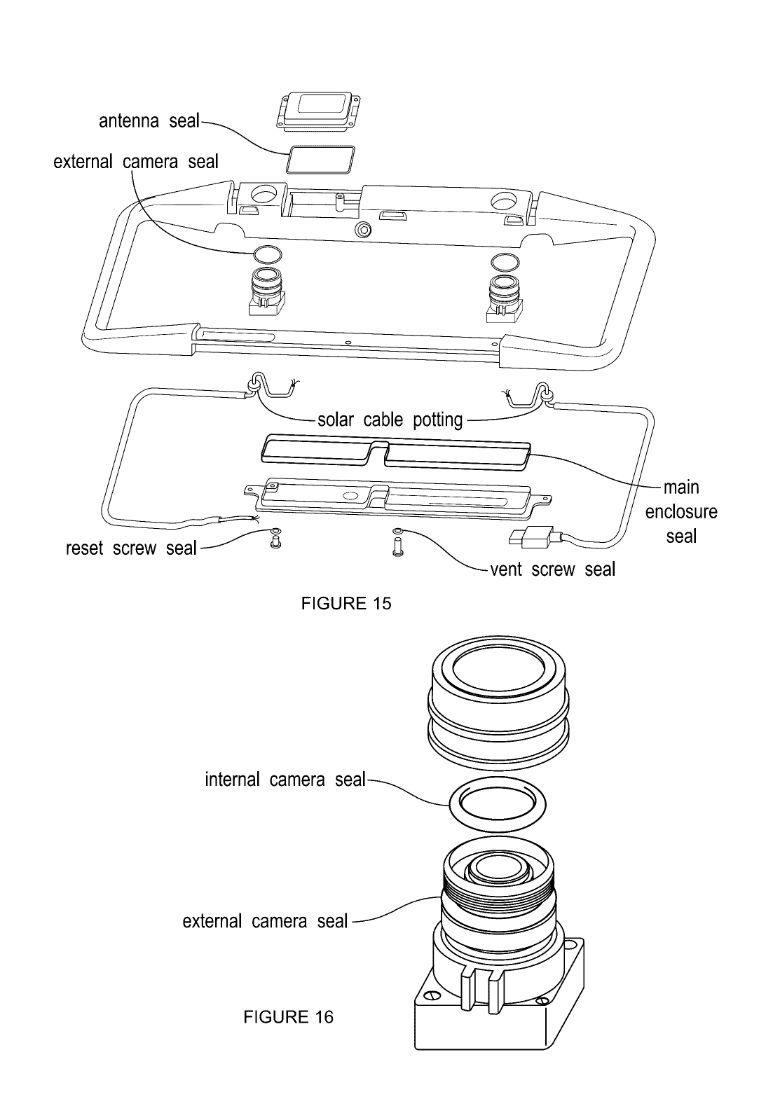

The casing 110 can additionally function to prevent fluid (e.g., liquid) ingress into the frame interior. This can function to protect active components from liquid in the ambient environment (e.g., due to carwashes, rain, etc.). In one variation, the casing no can include a set of gaskets 136 substantially aligned with each casing seam and/or mounting point (e.g., screw holes), example shown in FIG. 15. In a specific example, shown in FIG. 16, the camera can include a double gasket, and exclude a cover piece over the lens. In a second variation, the casing 110 includes a hydrophobic coating. In a third variation, the casing 110 can include a hood 138 extending over the lens, which can additionally shield the lens from solar flare or minimize other environmental interference with the recorded signals. However, the casing no can include any other suitable fluid-retardant and/or fluid-ingress-preventing component.

### 3.1.2 Sensors.

The sensor or sensors 140 of the vehicle sensor system 50 function to record measurements indicative of the vehicle sensor system 50 ambient environment. Preferably, the sensors 140 record measurements indicative of the vehicle ambient environment. The sensors 140 are preferably configured to sample and transmit a set of data. The sensors 140 can include cameras, orientation sensors (e.g., accelerometers, gyroscopes, IMUs, etc.), position sensors (e.g., GPS), temperature sensors, pressure sensors, acoustic sensors (e.g., microphones), light sensors (e.g., ambient light sensors), Hall effect sensors, magnetometers, proximity sensors (e.g., radar, lidar, sonar, photoelectric, inductive, etc.), touch sensors (e.g., resistive, capacitive, etc.), or include any other suitable sensor.

The camera can be a CCD sensor, CMOS sensor, or be any other suitable image sensor. The camera can be a multispectral camera, hyperspectral camera, or be configured to capture any suitable set of light wavelengths (e.g., visible light, infrared light, etc.). The camera can include a lens, wherein the lens can be a wide angle lens, standard lens, telephoto lens, macro lens, fisheye lens, or be any other suitable lens. The lens can be static or actuatable (e.g., wherein the lens can be selectively inserted before the camera). The lens can have a large barrel (e.g., to reduce reflections), small barrel, or have any other suitable configuration. The camera can additionally include a filter that is transparent to a predetermined subset of wavelengths and blocks a second subset of wavelengths. The camera can additionally include an illumination source (e.g., white light source, green light source, infrared light source). The illumination source can emit light continuously, or can be gated and/or synchronized with the camera shutter and/or detector. In some examples, the camera is a thermographic camera or a night vision camera. The camera is preferably configured to capture and transmit a set of image data. However, the camera can include any other suitable set of components with any other suitable set of parameters and/or be configured in any other suitable manner. In a specific example, a visible light camera within the casing 110 can have a fisheye lens and a visible light sensor, and the sensor module 100 can also have an infrared camera within the casing 110, the visible light camera and the infrared camera each electrically coupled to the communication system 150 (e.g., wherein the communication system 150 is a wireless communication module 152, each camera configured to transmit a set of images to the wireless communication module 152 by one or more electrical connections).

The sensor module 100 can include one or more sensors 140 of the same or different type. In a sensor module 100 that includes multiple cameras, the cameras can be arranged and/or configured to act cooperatively as a stereoscopic imaging system, or as a multispectral imaging system, or any other suitable imaging system, or additionally or alternatively can be arranged and/or configured to operate independently from each other, or in any other suitable manner. The sensor 140 can include an active surface that functions to record the measurements. The active surface is preferably arranged distal the vehicle-mounting face, but can alternatively be arranged proximal the vehicle-mounting face, or be arranged in any other suitable location.

The sensor 140 can be statically mounted to the frame or be movably mounted to the frame. The latter variation can confer the benefit of accommodating for different vehicle mounting surface angles, wherein the sensor 140 can be actuated to obtain substantially the same angle of view across different vehicle makes and models (e.g., in response to determination of the vehicle make and model by the hub 600, user device 500, or other system). In the latter variation, the sensor 140 can be mounted to the frame by a joint (e.g., a ball joint, hinge, etc.), gimbal, or any other suitable mounting system. Sensor 140 actuation relative to the frame can be controlled manually or automatically (e.g., by a motor controlled by the processing system 180).

In the example above, the sensor 140 or set of sensors 140 can be arranged within the main module region 128, but can alternatively be arranged elsewhere. In a specific example, the system can include a first and second camera arranged along opposing sides of the main module region 128. The first and second cameras are preferably arranged along an axis substantially parallel to the longitudinal axis 126 of the frame, but can alternatively be arranged along an axis substantially parallel to the lateral axis 125 of the frame, or be arranged in any other suitable configuration. The first and second cameras are preferably substantially the same distance from the lateral axis 125 of the frame, but can alternatively be asymmetrically arranged about the lateral axis 125. The intra-axial distance between the first and second camera can be approximately 6.35 cm, more than 6.35 cm, or less than 6.35 cm. The fields of view of the first and second cameras can be aimed at substantially the same physical region (e.g., such that the first and second cameras cooperatively form a stereocamera system), be aimed at different but overlapping physical regions, or be aimed at separate and discrete physical regions. The active regions of the first and second cameras can be substantially parallel the frame plane 124, angled toward the lateral axis 125, angled away from the lateral axis 125, angled toward the longitudinal axis 126, angled away from the longitudinal axis 126, or be arranged in any other suitable orientation. The first and second cameras are preferably substantially similar (e.g., be the same camera type, include the same lens, etc.), but can alternatively be different (e.g., be of different types, include different lenses, include different filters, etc.). Alternatively, the system can include a single camera. The single camera can be arranged within the main module region 128, or be located elsewhere. The single camera can be substantially aligned with the lateral axis 125, substantially aligned with the longitudinal axis 126, offset from the lateral axis 125, offset from the longitudinal axis 126, or be otherwise arranged. The camera active surface can be substantially parallel the frame plane 124, angled toward the lateral axis 125, angled away from the lateral axis 125, angled toward the longitudinal axis 126, angled away from the longitudinal axis 126, or be arranged in any other suitable orientation. However, the system can include any suitable number of cameras arranged in any suitable location with any suitable orientation.

The sensors 140 can additionally or alternatively include one or more accelerometers. The accelerometer is preferably mechanically coupled to the casing 110 and configured to sample and transmit a set of acceleration data, but additionally or alternatively can be mechanically coupled to any other component of the vehicle sensor system 50, the vehicle, any suitable secondary system, or any other suitable component.

### 3.1.3 Communication System.

The communication system 150 of the sensor module 100 functions to communicate sensor measurements (e.g., raw or processed) or other data to a secondary system. The communication system 150 can additionally or alternatively receive data from the secondary system, wherein the received data can be sensor operation instructions, data processing instructions, or be any other suitable set of vehicle sensor system control instructions. The secondary system is preferably the system generating a local communication network, but can alternatively be any other suitable system. The secondary system can be the hub 600, mobile device (e.g., user smartphone, tablet, etc.), or be any other suitable system. The communication system 150 is preferably electrically coupled to the set of sensors 140, more preferably configured to receive data from the set of sensors 140 through the electrical coupling, but additionally or alternatively can be configured to receive data from the set of sensors 140 through any other suitable means. The communication system protocol(s) preferably include a wireless communication protocol, but additionally or alternatively include a wired communication protocol. The wireless communication protocol can be a long-range communication protocol, such as Zigbee, Z-wave, or WiFi, but can alternatively be a short-range communication protocol, such as Bluetooth, BLE beacon, NFC, RF, IR, or any other suitable short-range communication protocol. The wired communication protocol can be Ethernet, powerline, USB, Lighting, or be any other suitable wired communication protocol.

The communication system 150 preferably includes a wireless communication module 152, but additionally or alternatively can include a wired communication module. The communication system 150 can support multiple protocols (e.g., be a multiradio system, support multiple protocols using a single radio) or support a single protocol. A multiradio system preferably has a high-power radio and a low-power radio, more preferably supporting a high-bandwidth and low-bandwidth protocol, respectively. A multiradio system can have radios that function on identical, similar, overlapping, or separate frequencies and/or frequency bands. In a multiradio system, multiple radios can transmit simultaneously, or radio usage can alternate between the radios such that multiple radios do not transmit simultaneously, or radio usage can follow any other suitable timing. For example, in a wireless communication module 152 with a high-power radio that supports a high-bandwidth protocol and a low-power radio that supports a low-bandwidth protocol, radio usage can alternate based on power and/or energy availability (e.g., battery state of charge, energy harvesting system power, etc.), bandwidth demands, and/or operational state (e.g., “standby” state, “active” state, vehicle reversing state, etc.). In a specific example, wherein the high-power radio supports a Wi-Fi protocol and the low-power radio supports a Bluetooth or BLE protocol, the low-power radio can be used to transmit and/or receive operational information (e.g., vehicle status, sensor module status, secondary system status, etc.) and/or commands (e.g., shutdown command, ready command, transmit command, etc.) while in a “standby” state, and the high-power radio can be used to transmit and/or receive sensor data (e.g., streaming video, etc.), and optionally operational information and/or commands, while in an “active” state.

The wireless communication module 152 can include an antenna 155. The antenna 155 functions to transmit information generated by the processing system 180 and/or receive information from the external system. The antenna directionality can be omnidirectional (e.g., monopole antenna, dipole antenna), directional (e.g., Yagi antenna, log-periodic antenna, parabolic antenna), or any other suitable antenna directionality. The antenna 155 can be a patch antenna, microstrip antenna, planar inverted-F antenna (PIFA), printed antenna, or be any other suitable type of antenna. The antenna 155 can be electrically grounded to an antenna carrier 156, the casing 110, or to any other suitable electrical ground. The antenna 155 can be oriented with respect to another antenna (e.g., an antenna of a secondary system), with respect to the vehicle, or with respect to any other suitable target. The antenna 155 can be arranged toward a target, at an angle from a target, or in any other suitable orientation with respect to a target, in order to affect the strength of communication between the antenna 155 and the target, or for any other suitable purpose. When the communication module includes multiple communication protocols, the system can include a single antenna 155 for multiple protocols, an antenna 155 per protocol, or multiple antennas 155 for each protocol. Multiple antennas 155 can be arranged in a plane, stacked along an axis in parallel, or otherwise arranged.

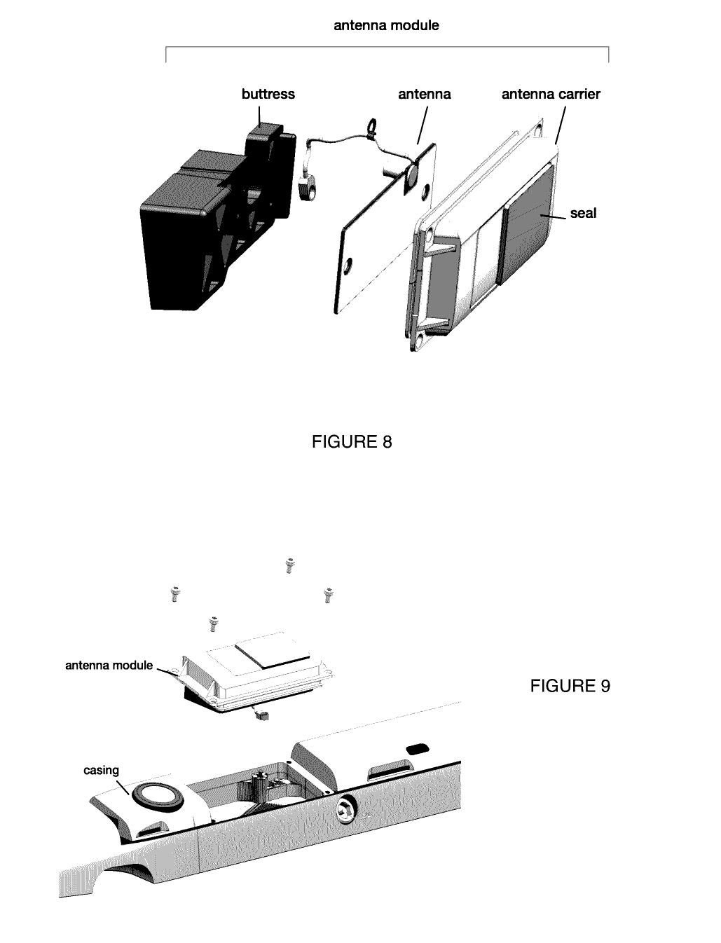

In one variation, as shown in FIGS. 8 and 9, the communication system 150 can additionally include an antenna carrier 156 housing the antenna 155, wherein the antenna carrier 156 and antenna 155 cooperatively form an antenna module 154. The antenna module 154 can additionally or alternatively include any other suitable set of components.

The antenna carrier 156 can function to retain the antenna 155, electrically ground the antenna 155, mechanically isolate the antenna 155 from the casing 110, and/or shield the antenna 155 from system EMI. The antenna carrier 156 can be made of metal, plastic, or any other suitable material. The antenna carrier 156 can be electrically conductive or electrically isolative. The antenna carrier 156 can include an antenna retention region that functions to retain the antenna 155. Each antenna carrier 156 can be configured to retain a single antenna 155 or multiple antennas 155. The antenna retention region can be a recess, groove, clip, or include any other suitable feature. The antenna 155 can be retained within the retention region by adhesive, magnets, clips, screws, or any other suitable retention mechanism. The antenna retention region is preferably parallel to and offset from the antenna carrier 156 center plane, but can alternatively be arranged along the center plane, at an angle to the center plane, or otherwise arranged.

The antenna carrier 156 can be configured to mount to the casing 110, more preferably within the antenna retention recess 134 but alternatively to any other suitable casing 110 location. The antenna carrier 156 can include mounting features configured to mount the antenna module 154 to the casing 110, such as screw holes, clips, hooks, tongues, grooves, or any other suitable mounting feature. The antenna carrier 156 can mount to the casing 110 with the antenna 155 proximal the casing exterior 111, but can alternatively be mounted proximal the casing interior 112. When mounted to the casing 110, the antenna carrier 156 and casing 110 preferably cooperatively form an air gap between the antenna 155 and the casing 110. However, the antenna carrier 156 can mount the antenna 155 substantially flush with the casing 110, or retain the antenna 155 in any other suitable orientation relative to the casing 110.

In one variation, the antenna carrier 156 can be separated from the casing 110 by a seal. The seal or gasket can function to electrically isolate the antenna carrier 156 from the casing 110, and/or mechanically isolate the antenna carrier 156 from the casing 110. The seal can be electrically isolative or be electrically conductive. Electrically isolating the antenna carrier 156 from the casing 110 can confer several benefits. In particular, the electrically isolated antenna carrier 156 can function as a uniform ground reference for the antenna 155, such that the antenna performance is not affected by the vehicle mounting surface material, the vehicle shape, or any other suitable vehicle parameter (e.g., whether the vehicle includes a sunroof). Examples of seal material include foam, rubber, or any other suitable material.

The system can optionally include a heatsink that functions to cool the communication module. The heatsink can additionally function as an EMI shield, thermal connection, electrical connection, or perform any other suitable function. In a first variation, the heatsink thermally connects to the communication module and radiates heat from the communication module (e.g., antenna 155, antenna carrier 156, antenna chipset, etc.) to the ambient environment. In a second variation, the heatsink thermally connects to the communication module and conducts the heat to a secondary heatsink (e.g., the vehicle, a license plate, the casing, the backing plate, etc.). However, the heatsink can be otherwise configured and connected.

### 3.1.4 Power System and Charging Methods.

The power system 160 of the sensor module 100 functions to provide power to the sensor module 100. The power system 160 can include a power storage device 161, an energy harvesting system 163 (charging system), a power connector 165, and/or any other component capable of providing power to the sensor module 100. The power system 160 is preferably electrically coupled to the processing system 180, the communication system 150, and/or the set of sensors 140. The power system 160 can additionally include a power management system 169 that functions to condition the power provided by the power system 160 into power suitable for the endpoint. The power management system 169 can additionally function to regulate power system 160 charge, discharge, and state of charge. The power system 160 can be arranged in the energy harvester support region 130, the main module region 128, the arm(s) 114 connecting the energy harvester support region 130 and the main module region 128, and/or be arranged in any other suitable portion of the casing no.

The power storage device 161 functions to receive, store, and/or provide energy, and preferably is a secondary battery (rechargeable battery) of Lithium chemistry, Nickel Cadmium chemistry, or any other suitable chemistry. The secondary battery can include one or more cells, connected in series, parallel, and/or a combination thereof. Additionally or alternatively, the power storage device 161 can be a primary battery, capacitor, fuel cell, mechanical energy storage device (e.g., a flywheel), or be any other suitable energy storage device. The power storage device 161 can include a battery management system (BMS) configured to monitor the power storage device 161 SOC (state of charge). The BMS or another system can additionally regulate power storage device 161 charging and discharging. The power management system 169 can additionally monitor the power storage device 161 SOC, and generate a user notification in response to the SOC falling below a SOC threshold.

The energy harvesting system 163 (charging system) functions to harvest energy from the ambient environment and/or from vehicle and/or vehicle sensor system 50 motion. The energy harvesting system 163 can be a solar charging system (e.g., including a set of solar panels), a wind turbine (e.g., configured to harvest energy from air flowing past the vehicle), a piezoelectric harvester (e.g., configured to harvest energy from vehicle vibrations), or be any other suitable energy harvesting system 163. The energy harvesting system 163 can be electrically coupled to and cooperatively used with the power storage device 161, wherein the energy harvested by the energy harvesting system 163 can be stored within the power storage device 161 for later use. Alternatively, the energy harvesting system 163 can be used alone, without the power storage device 161, or be used in conjunction with any other suitable power system 160. The power management system 169 can additionally monitor the energy harvesting rate and/or power provision rate of the energy harvesting system 163, and generate a user notification (e.g., positive feedback) in response to the energy harvesting rate exceeding a threshold power provision rate.

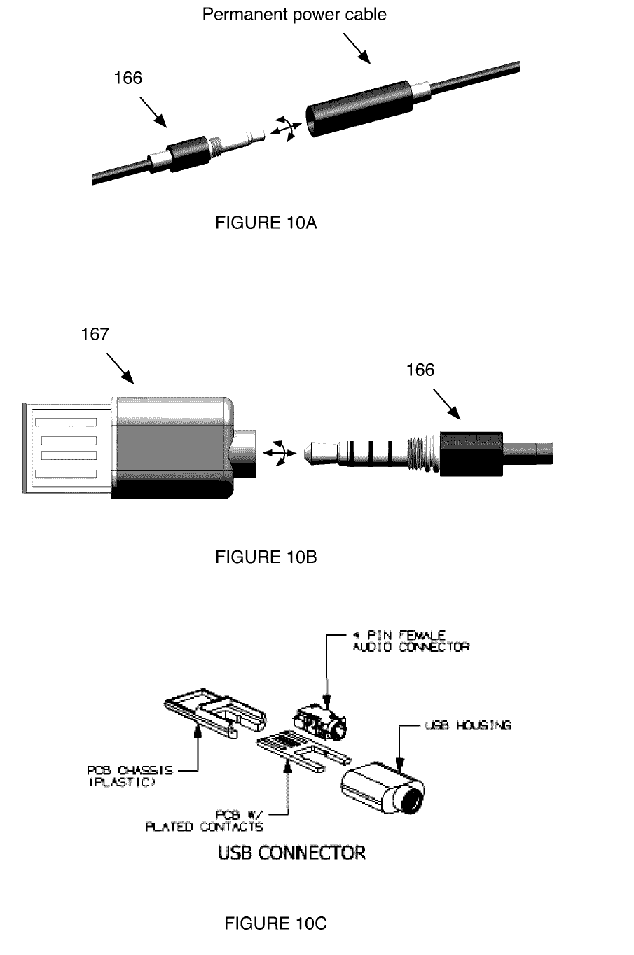

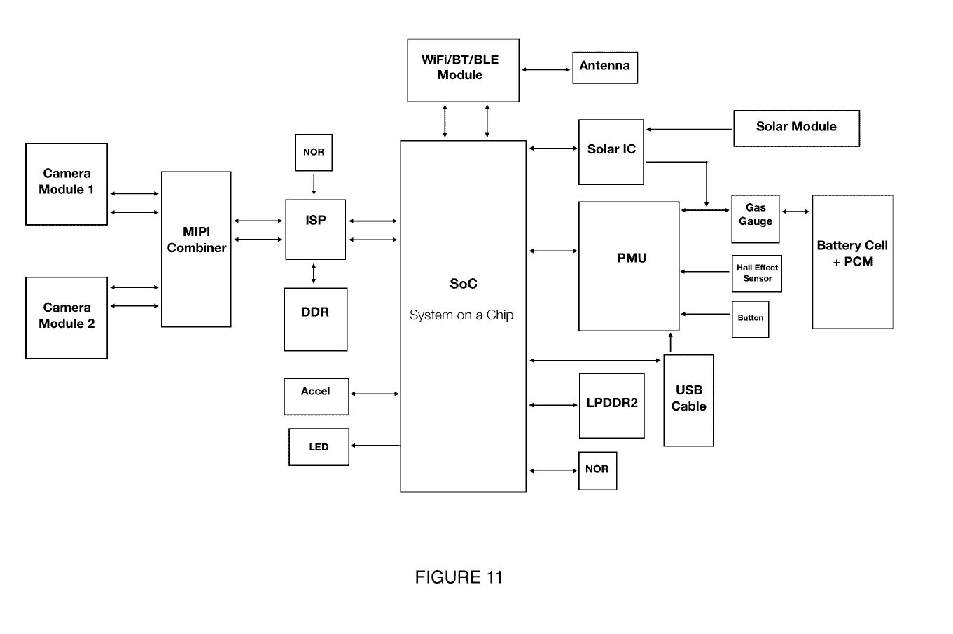

The power connector 165 functions to connect the sensor module 100 to an external power source (e.g., the vehicle, a power grid, etc.). The power connector 165 is preferably an electrical power connector, but alternately can be a mechanical power connector, an acoustic power connector, or a connector configured to transmit any other suitable type of power. The power connector 165 is preferably a wired connector (e.g., a USB connector, permanent power connector, a universal connector 166 configured to connect to any suitable connector head, as shown in FIGS. 10A and 10B, etc.), but can alternatively be a connection jack (e.g., a male or female connector configured to connect to a wired connector), a contact connector (e.g., flush with the casing surface), a sprung connector, a wireless connector (e.g., induction coil, etc.), or be any other suitable connector. In one variation, the power connector 165 can be defined by the one or more bosses on the casing 110, wherein the bosses can be electrically conductive. However, the power connector 165 for the sensor module 100 and/or hub boo can be otherwise defined. The power connector 165 is preferably on the exterior of the casing 110 (e.g., a jack located within a recess defined in the casing exterior 111, a wire extending from the casing exterior 111, etc.), but alternatively can be in any other suitable region of the casing 110, or included in any other suitable component of the system.

The power connector 165 is preferably removably couplable to the external power source, more preferably removably couplable without tools (e.g., USB connector, banana connector, NEMA connector) but alternatively requiring tools for assembly and/or removal (e.g., insulation displacement connector, ring terminal connector); but alternatively can form a permanent connection (e.g., soldered connection, crimped connection) or any other suitable type of connection. The power connector 165 can include a universal connector 166 removably couplable to a variety of headers 167 (e.g., as shown in FIGS. 10A and 10B), or include a connector couplable to a limited subset of contacts. The power connector 165 can include both power and data contacts (e.g., pins), such that the power connector 165 can transmit both power and data, concurrently or asynchronously. Alternatively, the power connector 165 can transmit only power. In the latter variation, the system can optionally include a separate data connector. The power connector 165 can be cooperatively used with the power storage device 161, wherein the power connector 165 can charge the power storage device 161 with power from the external source, but can alternatively be used alone or in conjunction with any other suitable power system 160.

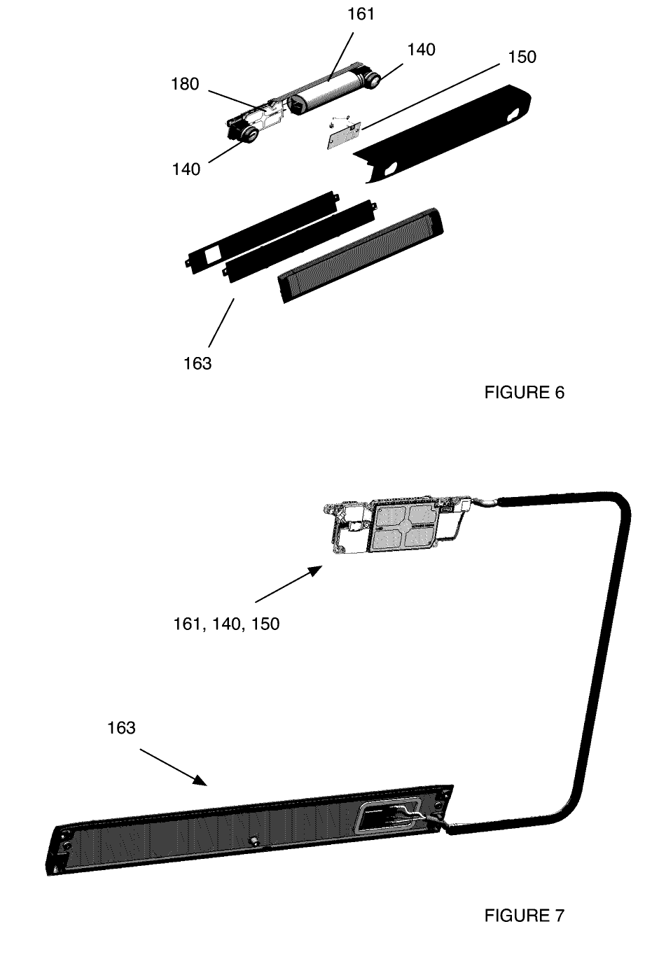

In a specific example, as shown in FIG. 6, the sensor module 100 can include a power system 160 that includes a rechargeable battery, a solar charging system, and a wired power connector. The rechargeable battery is electrically connected to the processing system 180, and the solar charging system and wired power connector are electrically connected to the rechargeable battery, wherein the rechargeable battery can additionally function to condition the received power for the sensor module components. The solar charging system and wired power connector can additionally or alternatively be electrically connected to the sensor module components. In this variation, the rechargeable battery can be arranged in a first arm of the casing no and the energy harvesting system 163 can be arranged in a second arm of the casing no (e.g., wherein the second arm opposes the first arm). The energy harvesting system 163 can be electrically connected to the rechargeable battery by a first wire having a first end electrically coupled to the energy harvesting system 163 and a second end electrically coupled to the battery. The first wire can extend through a lateral arm 115 (example shown in FIG. 7), and the wire of the wired power connector can be removably retained within the cord storage groove 132. The wired power connector can be a USB power connector, a 12V permanent power connector configured to connect to the vehicle power system 160, a permanent power connector with a USB or other connector adapter, or be any other suitable connector.

In operation, a system variant including both an energy harvesting system 163 and a rechargeable battery harvests energy using the energy harvesting system 163 and recharges the battery with the harvested energy. In a first variation, in response to the rechargeable battery SOC exceeding an SOC threshold and/or the energy harvesting system 163 providing energy above a threshold rate, the sensor module 100 or any other suitable component of the vehicle sensor system 50 can be operated in a high power mode (e.g., recording measurements with the sensors 140 at a faster rate, operating the communication module 150 at a faster rate, operating a higher-power communication channel, etc.). Alternatively or additionally, the excess power can be rerouted to charge auxiliary devices connected to the vehicle sensor system 50. In a second variation, the energy harvesting system 163 can be disabled (e.g., disconnected, electronically disabled, etc.) in response to the ambient temperature exceeding a threshold temperature, and re-enabled in response to the ambient temperature falling below the threshold temperature. The ambient temperature can be measured by the temperature sensor of the vehicle sensor system 50, of the vehicle, of the mobile device, or of any other suitable system. In this variation, the method can additionally include discharging the rechargeable battery to or below a target SOC when the ambient temperature exceeds the threshold temperature. The target SOC can be determined based on the ambient temperature, based on the time duration since last use (e.g., dormant duration), based on the anticipated time until next use (e.g., storage duration), be predetermined, and/or be otherwise determined. However, the power system 160 can be otherwise operated.

### 3.1.5 Processing System 180.

The processing system 180 of the sensor module 100 functions to control sensor module operation. The processing system 180 can function to control power system 160 operation (e.g., energy harvesting system 163 operation, battery management, etc.), sensor operation, sensor measurement processing (e.g., video dewarping, cropping, stabilization, etc.), measurement encoding, or perform any other suitable functionality. In one variation, the processing system 180 can selectively operate different sensors 140 and/or outputs based on auxiliary sensor signals. In one example, the processing system 180 can automatically operate (e.g., power, use signals from, etc.) a first camera (e.g., visible range camera) in response to flare detection (e.g., based on image analysis), the ambient light falling below a threshold value and the vehicle's make and/or model falling a predetermined set of makes and/or models, or in response to the satisfaction of any other suitable condition. In another example, the processing system 180 is configured to receive a set of image data from a camera (e.g., a camera attached to the housing) and a set of acceleration data from an accelerometer (e.g., an accelerometer attached to the housing), and stabilize the set of image data based on the set of acceleration data. However, the processing system 180 can be configured to operate in any other suitable manner. The processing system 180 can be a CPU, GPU, microprocessor, or be any other suitable processing system 180. The processing system 180 can additionally include dedicated hardware that functions to perform specified functions. For example, the processing system 180 can include an encoding circuit (e.g., an H.264 encoder) that functions to encode the video stream, a dewarping circuit (e.g., an image signal processor with software-controllable geometric dewarping) that functions to dewarp the video stream, or include any other suitable purpose-built silicon configured to perform a specific function. Alternatively, the specified functions can be performed by software in generic circuitry. The processing system 180 is preferably arranged in the main module region 128, but can alternatively be arranged in the energy harvester support region 130, in a lateral arm 115, or in any other suitable location within the casing 110.

The processing system 180 can be mounted to the casing no, suspended from the casing no, or otherwise configured. The processing system 180 can include connections to secondary boards. In one variation, the board-to-board connection can be suspended, which can result in a smaller system footprint. In a second variation, the board-to-board connection can be wired. In a third variation, the board-to-board connection can be defined through and/or by the casing 110. However, the board-to-board connection can be otherwise configured. The board-to-board connection can be shielded by the heatsinks or by any other suitable EMI shield.

### 3.1.6 Weight and Component Arrangement.

The sensor module 100, sensor module 100 and backing plate 200, or any other component or combination of components of the vehicle sensor system 50 can have a total weight of 10-15 oz, 12.5-13.5 oz, 13.1 oz, or any other suitable weight. The sensor module 100 can have a sensor module weight distribution 190, the sensor module weight distribution 190 including a sensor module center of mass 192 distal a rear plane 120 across a frontal plane 119 (e.g., wherein the rear plane 120 and frontal plane 119 are defined relative to a support region 121). The sensor module 100 can include a top region opposing a mating surface (discussed below), the top region containing the sensor 140, the wireless communication module 152, and the battery. In a specific example, the sensor 140, wireless communication module 152, and battery can be arranged in a main module region 128 in the top region such that the projection of the sensor module center of mass 192 along a gravity vector (e.g., when the sensor module 100 is installed on a vehicle, when the lateral arms 115 are aligned with a gravity vector, etc.) lies outside the support region 121, as shown in FIG. 21. In this specific example, when the sensor module retention mechanism 170 is not engaged with the backing plate retention mechanism 210, the force exerted by gravity can cause the sensor module 100 to rotate (e.g., about an axis lying substantially along the sensor module mating surface 118, about an axis defined by the support region 121, about a sensor module pivot axis 122, etc.). However, the sensor module weight can be evenly distributed, offset to a side, offset to a corner, or otherwise distributed.

### 3.4 Mounting Mechanism.

The casing 110 can include a mounting mechanism, which functions to mount the casing to the vehicle. The mounting mechanism can optionally function as an alignment mechanism, which aligns the casing with a portion of the vehicle (e.g., the vehicle license plate). The mounting mechanism can optionally function as a retention mechanism 170, which retains the casing position relative to the vehicle.

The mounting mechanism can be removable from the sensor module 100 (e.g., wherein the mounting mechanism is a screw, the sensor module 100 forms a thru-hole with diameter larger than the screw shaft and smaller than the screw head to accommodate the screw) or attached to the sensor module 100 (e.g., a captive screw). The mounting mechanism can be electrically coupled to one or more components of the sensor module 100 and to the backing plate 200, the vehicle, or any other suitable ground, wherein the mounting mechanism can function to ground the electrically coupled components of the sensor module 100, to power the electrically connected components, be powered by the electrically coupled components, or be otherwise configured.

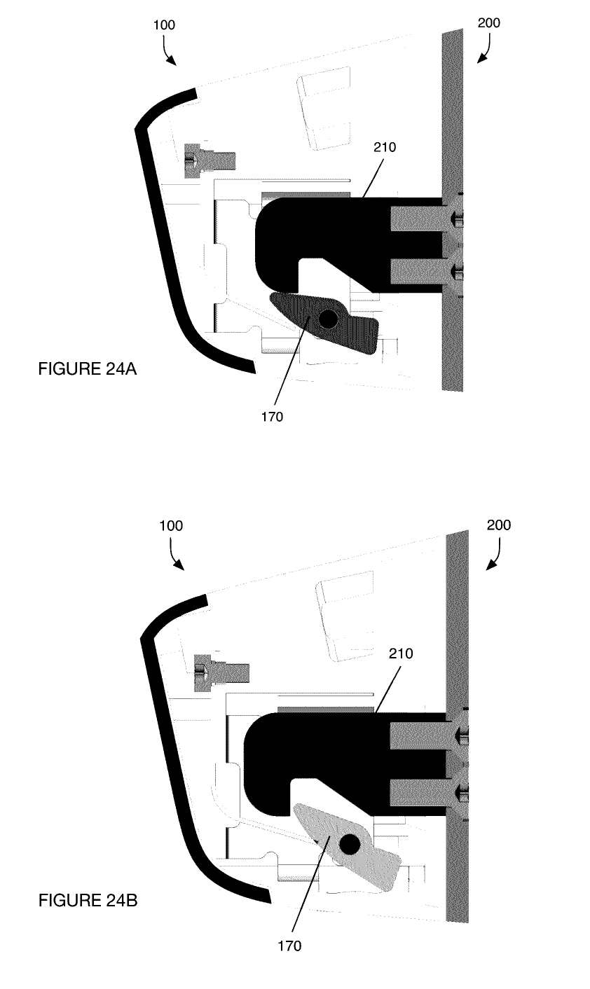

The mounting mechanism preferably removably mounts the casing to the vehicle, but can alternatively permanently mount the casing to the vehicle. The mounting mechanism can directly or indirectly mount the casing to the vehicle. For example, the mounting mechanism can mount the casing to a backing plate, wherein the backing plate is mounted directly to the vehicle. The mounting mechanism is preferably removably couplable to a complementary mounting mechanism of the backing plate 200 (e.g., a set of eyes sized to accept the set of hooks, a second magnet oriented such that the magnets attract each other, a hook to retain a moveable latch, etc.; example shown in FIGS. 24A-B), but additionally or alternatively can be removably or permanently couplable to any suitable component (e.g., the backing plate 200, the vehicle, etc.).

When the casing defines a portion of the mounting mechanism, the casing can include a sensor module mating surface 118 extending along a casing surface, wherein the mating surface 118 can be couplable to a complementary mating surface of another component. The other component is preferably another component of the vehicle sensor system 50, more preferably a backing plate 200, but can alternatively or additionally be a component of a vehicle (e.g., a license plate, a body panel, an axle, a seat), or any other suitable component. The sensor module mating surface 118 is preferably removably couplable to the complementary mating surface, but alternatively can be permanently coupled or couplable to the complementary mating surface. The sensor module mating surface 118 and complementary mating surface are preferably couplable by direct contact of the two surfaces, but alternatively or additionally can be otherwise couplable. The sensor module mating surface 118 and complementary mating surface are preferably in forms that allow a significant portion of the two surfaces to contact or nearly contact each other (e.g., both surfaces are planar, the surfaces form interlocking features, etc.), but can alternatively be configured to minimize surface contact or be otherwise configured. In one example, one mating surface forms a groove with a curved cross-section, the other mating surface forms a convex surface that fits within the groove, the cross-section of the convex surface having a similar radius of curvature as the cross-section of the groove. The sensor module mating surface 118 is preferably on one or more of the arms 114 of the casing 110 (e.g., on a second arm, on both a first arm and a third arm, etc.), more preferably on a lower portion of an arm 114 (e.g., wherein the sensor module 100 is installed on a vehicle, on a bottom surface of a lower arm), but additionally or alternatively can be on any suitable region or regions of the casing 110 (e.g., front plane, back plane, etc.). The sensor module mating surface 118 can define a sensor module support region 121. The sensor module support region 121 can be: the region of the sensor module mating surface 118, the region defined between adjacent sensor module mating surfaces 118, the convex hull of the regions in which the sensor module mating surface 118 and a complementary mating surface are in contact, or be otherwise defined.

The mounting mechanism can include a mechanical mounting mechanism (e.g., joints, adhesives, screws, hooks, etc.), a magnetic mounting mechanism (e.g., permanent magnets, electromagnets, ferrous materials, etc.), or include any other suitable mounting mechanism. The system can include one or more mounting mechanisms of similar or differing types. The mounting mechanism can be arranged along the exterior surface of the casing (e.g., along a broad face, along an external or internal edge, etc.), through the casing thickness, within the casing, along the interior surface of the casing, or at any suitable portion of the casing.

In a first variation, the mounting mechanism includes a joint cooperatively formed by the casing and a complimentary mounting component (e.g., backing plate, vehicle, etc.). The joint functions to retain the casing position relative to the vehicle and to align the casing relative to the vehicle. The joint can define the mating surfaces along the joint interface (e.g., along the tongue and groove interfaces), or otherwise define the mating surfaces. The joint can extend parallel the sensor module longitudinal axis (e.g., be a longitudinal joint), parallel the sensor module lateral axis (e.g., be a lateral joint), at an angle between the sensor module longitudinal axis and lateral axis, or extend along any other suitable portion of the system.

The joint can be formed by a tongue and groove set, or be otherwise constructed. The tongue can be defined by the casing or by the complimentary mounting component. The groove can be defined by the casing or by the complimentary mounting component. In a first example, the casing defines a longitudinal groove extending along a lower arm of the casing, distal the upper arm of the casing. The backing plate includes a longitudinal convex protrusion (e.g., a tongue) that fits into the longitudinal groove. In a second example, the casing defines the longitudinal tongue and the backing plate defines the longitudinal groove. In a third specific example, the casing can define a set of lateral grooves extending perpendicular the longitudinal axis, while the backing plate defines a set of lateral tongues complimentary to the lateral grooves (e.g., arranged in complimentary positions, constructed with complimentary profiles, etc.). However, the joint can be otherwise defined.

The joint can additionally function to enable free and/or limited casing movement relative to the vehicle. In one embodiment, the joint allows casing rotation within a predefined angular range relative to the vehicle, and prevents casing rotation beyond the predefined angular range. In one example, portions of the casing proximal the joint component (e.g., parallel the joint component, adjacent the joint component) can interact with (e.g., abut against) portions of the complimentary mounting component to prevent further casing rotation, such that the casing portions and/or complimentary mounting component portions function as barrier members. In a specific example in which the casing defines the groove, the groove can be slightly wider and deeper than the tongue defined by the backing plate, such that the casing can rotate about a front casing edge until an interior surface of the groove contacts the tongue and prevents further casing rotation. In a second specific example in which the backing plate defines the groove (e.g., ledge) and the casing defines the tongue, the tongue can be radiused such that the casing rotates within the groove until the front surface of the casing contacts the front edge of the groove. However, casing rotation can be otherwise enabled and/or controlled. In a second embodiment, the joint allows free lateral casing translation (e.g., along a major joining axis). However, the joint can otherwise enable casing movement.

In a second variant, the mounting mechanism can include a screw and hole set, wherein the hole has threading complementary to the screw. The hole can be defined in the complementary mounting component (e.g., the backing plate), the casing, and/or any other suitable component. The hole can be angled relative to the major casing plane, perpendicular to the major casing plane, parallel to the major casing plane, or otherwise arranged. The screw can be removable relative to the system, captive within the system (e.g., within the casing), or otherwise retained relative to the casing.

In a third variant, the mounting mechanism can include a magnetic mounting system, wherein the casing can include a first magnetic element magnetically attracted to a second magnetic element of the complementary mounting component, such that the first and second magnetic elements cooperatively form a magnetic element pair. The magnetic attraction between the elements of the pair preferably generates a retention force sufficient to overcome the weight of the sensor module, but can alternatively generate an attractive force of any other suitable magnitude. The first and/or second magnetic element can include: a ferrous element (e.g., plate, material, etc.), a permanent magnet, an electromagnet, or any other suitable magnetic element. In a first variation, the sensor module can include an electromagnet powered by the sensor module power source. In this variation, the electromagnet can be automatically released (e.g., de-powered) when the power source (e.g., battery) falls below a threshold SOC. This can function as a signal to the user to recharge the sensor module using the power connector 165. In a second variation, either the sensor module or the complementary mounting component can include a permanent magnet, wherein the other includes a ferrous element (e.g., ferrous plate or complimentary magnet). However, the magnetic mechanism can be otherwise configured.

In a fourth variation, the mounting mechanism includes a combination of the first variation and the second or third variation. In this variation, the system includes an alignment mechanism (e.g., the joint) defined between a first edge of the casing and complimentary mounting component, and a retention mechanism (e.g., the screw or magnetic mechanism) along an opposing edge (opposing the first edge) of the casing and complimentary mounting component.

In one example of this variation, the casing 110 removably or permanently mounts to a backing plate 200. In a specific example, as shown in FIGS. 12A-12C, the casing 110 is retained along a first edge (e.g., bottom edge, bottom longitudinal edge, right lateral edge) at a sensor module mating surface 118 by a backing plate mating surface 220 on a groove or ledge defined by the backing plate 200, and retained along an opposing edge (e.g., top edge, top longitudinal edge, left lateral edge) by a screw that serves as a sensor module retention mechanism 170. The screw can be arranged proximal the middle of the opposing edge, be arranged offset from the opposing edge center, or be arranged in any other suitable location. In the specific example, frame installation can include: inserting the frame into the groove; pivoting the frame about the first edge, such that the opposing edge contacts the backing plate 200; and retaining the opposing edge against the backing plate 200 with the screw (e.g., wherein the screw is screwed in to a threaded hole defined by the backing plate 200, the threaded hole serving as a backing plate retention mechanism 210 and having threading complementary to the threading of the screw). Frame removal can include: loosening the screw from the backing plate 200; pivoting the frame about the first edge or allowing the frame to pivot about the first edge; and using the opposing edge as a handle to lift or slide the frame out of the groove. The screw coupling axis 172 (e.g., retention axis) is preferably at an acute angle to the frame plane 124, more preferably wherein the in-frame-plane component of a vector oriented along the screw coupling axis 172 and directed outward from the frame points substantially downward and/or toward the first edge (e.g., as shown in FIG. 12A) but alternatively wherein the in-frame-plane component has any other suitable orientation; but can alternatively be parallel to the frame plane 124; normal to the frame plane 124; or be at any other suitable angle to the frame plane 124. In this example, the screw can function as the security mechanism, and include a unique or proprietary drive.

In this example, the frame preferably extends over the bolts used to retain the backing plate 200 against the vehicle, and includes recesses or grooves to accommodate the bolt heads protruding from the backing plate 200 (example shown in FIG. 5B). However, the frame can alternatively include cutouts or not extend over the bolts. As shown in FIG. 5A, the frame can additionally include a main module region 128 that preferably extends outward from the frame plane 124. This can function to provide sufficient room to house the sensor electronics. This can also function to locate the active regions of the sensor(s) outward of the vehicle, such that the sensor active regions can clear vehicle components. In a specific example, the main module region 128 can retain the cameras such that the vehicle bumper is outside of, or less than a threshold percentage of the camera field of view. The main module region 128 can have a thickness between 120 mm and 140 mm, 130 mm, between 0.75 inch and 1.25 inch, 1 inch, or have any other suitable dimensions. The main module region 128 is preferably arranged along the opposing edge, but can alternatively be arranged along the first edge or the intermediary edges connecting the opposing edge with the first edge. The main module region 128 is preferably arranged along the frame face opposing the vehicle-mounting face, but can alternatively be defined along the vehicle-mounting face.

In this example, the frame can additionally include a lower portion that functions as a sensor module mating surface 118 to support the frame within a complementary mating surface of the backing plate 200. The lower portion can have a rounded or curved edge that functions to interface with the backing plate 200 (e.g., pivot within a groove of the backing plate 200). However, the lower portion can have angled edges, or have any other suitable profile. However, the mounting mechanism can be otherwise constructed.

The mounting mechanism can optionally function as a security system, which prevents unauthorized removal of the casing from the vehicle. In a specific example, wherein the backing plate retention mechanism 210 includes a threaded hole, the sensor module retention mechanism 170 includes a security screw with threading complementary to the threaded hole, such that the backing plate 200 and sensor module retention mechanism 170 are removably couplable (e.g., as shown in FIG. 20). The security screw can include a custom drive pattern, a magnetic coupling mechanism (e.g., wherein the magnetic coupling mechanism is not released unless a tool generating a magnetic field with a set of predefined parameters is used), or include any other suitable security feature. Alternatively, the system can include a separate security system that hinders unauthorized system removal from the vehicle. The security system and/or retention mechanism can be a mechanical system (e.g., uniquely keyed screw, screw with proprietary drive, lock, etc.), radio verification system (e.g., unlocked in response to verification of the user device 500, vehicle key chip, etc.), biometric system (e.g., fingerprint system, etc.), or include any other suitable security system.

The vehicle sensor system 50 (preferably the sensor module 100, but additionally or alternatively the backing plate 200 or any other suitable vehicle sensor system component) can additionally include one or more attachment sensors (e.g., pressure sensors, electrical sensors, proximity sensors, magnetic sensors, etc.), which can optionally function to detect whether the sensor module 100 is installed (e.g., attached to the vehicle, attached to the backing plate 200, etc.). In a first example, the attachment sensor is a hall effect sensor arranged in the sensor module 100 such that it can detect the proximity of a magnet in the backing plate 200 when the sensor module 100 is attached to the backing plate 200 (e.g., as shown in FIGS. 24A-B). In a second example, the attachment sensor is a pressure sensor arranged in the sensor module 100 such that it is depressed when the sensor module 100 is installed (e.g., by pressing against a surface to which the sensor module 100 is mated). In a third example, the attachment sensor is an electrical sensor that detects when two exposed conductive pads on the exterior of the sensor module casing 110 are electrically connected (e.g., by a conductive path on the backing plate 200 that contacts the two pads when the sensor module 100 is attached to the backing plate 200). However, the attachment sensor can be any suitable sensor arranged in any suitable manner.

### 3.3 Backing Plate 200.

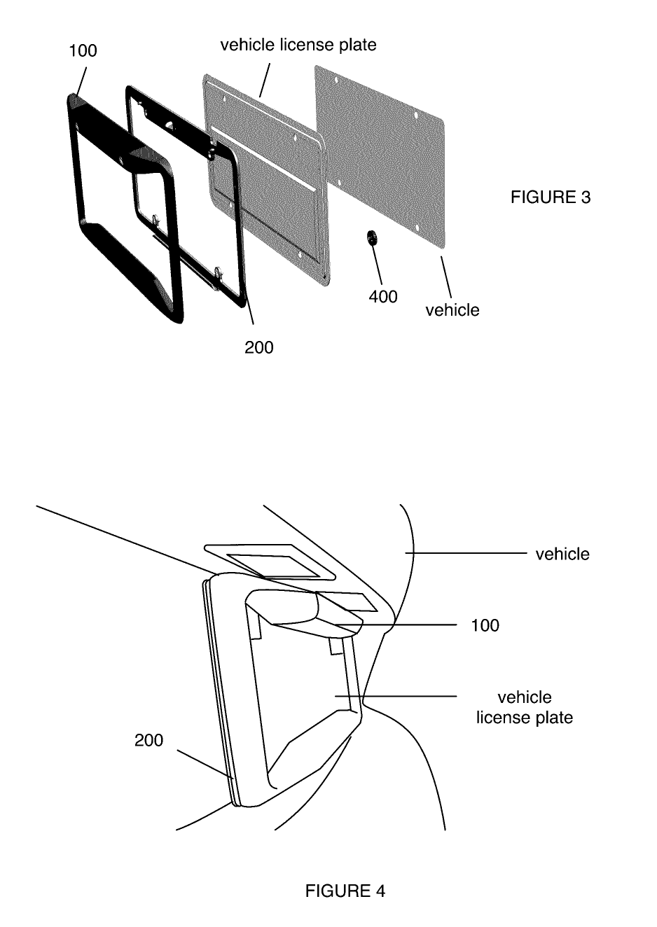

The vehicle sensor system 50 optionally includes a backing plate 200 that functions to mount to the vehicle (e.g., to predefined, standard license frame mounting points, to previously undefined mounting points, etc.), to retain the license plate against the vehicle (example shown in FIG. 3), and to define mounting points for the sensor module 100. The backing plate 200 can function as a mount for the sensor module 100 to attach the sensor module 100 to the vehicle. The backing plate 200 preferably attaches the sensor module 100 to the vehicle removably, but alternatively can attach the sensor module to the vehicle permanently. The backing plate 200 is preferably configured to couple to the vehicle such that a license plate is arranged between the vehicle and the backing plate 200, but can alternatively be configured to couple to any other suitable component of the vehicle in any other suitable manner.

The backing plate 200 can include a backing plate retention mechanism 210 (e.g., threaded hole, hook, magnet, etc.). The backing plate retention mechanism 210 preferably is couplable to the sensor module (e.g., to retention mechanism 170), more preferably removably couplable but alternately permanently couplable to said retention mechanism, but additionally or alternatively can be couplable to any other suitable component of the vehicle sensor system 50, the vehicle, or any other suitable component.

The backing plate 200 can include a backing plate mating surface 220. The backing plate mating surface 220 can be complementary to the sensor module mating surface 118, such that the backing plate mating surface 220 is a mating surface to which the sensor module mating surface 118 is removably couplable. The backing plate mating surface 220 is preferably arranged on a bottom region of the backing plate 200 (e.g., relative to a gravity vector when the backing plate 200 is installed on a vehicle), but additionally or alternatively can be arranged on any other suitable region of the backing plate 200. The backing plate mating surface 220 preferably defines a groove or ledge on which the sensor module mating surface 118 can rest, but can additionally or alternatively define a tongue or any other suitable mating surface feature.

In one embodiment in which the backing plate 200 includes a backing plate mating surface 220 complementary to the sensor module mating surface 118, the backing plate 200 can enable convenient removal and reinstallation of the sensor module 100 (e.g., as shown in FIGS. 12A-12C). In one variation, the sensor module mating surface 118 can be supported by the backing plate mating surface 220, and a portion of the sensor module 100 opposing the sensor module mating surface 118 can be retained against the backing plate 200 by a backing plate retention mechanism 210. In this variation, a bias generating mechanism 300 can be configured to bias the sensor module 100 away from the backing plate 200 (e.g., exert a force opposed by the backing plate retention mechanism 210), and the backing plate retention mechanism 210 can be configured to operate in a retaining mode and a non-retaining mode. For example, when the backing plate retention mechanism 210 is switched from the retaining mode to the non-retaining mode, the sensor module 100 can pivot away from the backing plate 200 about a sensor module pivot axis 122 (e.g., pivot in a groove defined by the backing plate mating surface 220), due to the bias generated by the bias generating mechanism 300. In this example, the sensor module 100 can then be lifted off the backing plate mating surface 220 (e.g., by a user). The backing plate 200 and/or sensor module 100 can have one or more barrier members 60 (e.g., an extended outer lip of a groove, a retaining clip, a member proximal to a sensor module mating surface as shown in FIG. 22, etc.) that prevent the sensor module 100 from moving past a certain point (e.g., pivoting past a limit angle, translating farther than a limit distance, etc.) during a move caused by the bias generating mechanism 300.

### 3.4 Bias Generating Mechanism.

The vehicle sensor system 50 optionally includes a bias generating mechanism 300. The bias generating mechanism 300 can be included in the sensor module 100, the backing plate 200, any other suitable component of the vehicle sensor system 50 and/or the vehicle, and/or any other suitable component. The bias generating mechanism 300 can include a spring (e.g., compression spring, torsion spring, coil spring, leaf spring, pneumatic spring, etc.), a set of magnets (e.g., permanent magnets, electromagnets, etc.), a weight distribution (e.g., sensor module weight distribution 190), or any other suitable mechanism.

The bias generating mechanism 300 can be configured to bias the sensor module 100 away from the backing plate 200. The generated bias can be a force (e.g., directed outward in a direction normal to the frame plane 124, at an angle to the frame plane 124, aligned with or opposing a gravity vector, or in any other suitable direction), a torque (e.g., about an arm 114 of the sensor module 100, about an axis parallel to the lateral 125 or longitudinal axis 126, about any other suitable axis), or any other suitable bias.

In one embodiment, the bias generating mechanism 300 includes a sensor module weight distribution 190. In one variant of the embodiment, in which the support region 121 defines a frontal plane 119 and a rear plane 120, the sensor module weight distribution 190 includes a center of mass distal the rear plane 120 across the frontal plane 119. In a specific example of this variant, in which the frontal plane 119 and the rear plane 120 are parallel to a gravity vector, the force of gravity acting on the sensor module 100 and the contact force exerted on the sensor module 100 support region 121 cooperatively bias the sensor module 100 away from the backing plate 200, as shown in FIG. 21. However, the bias generating mechanism 300 can be configured in any other suitable manner.

### 3.4 Vibration Reduction Mechanism.

The vehicle sensor system 50 optionally includes a vibration reduction mechanism 400 that functions to reduce the vibration of the sensor module 100. The vibration reduction mechanism 400 can include active components (e.g., pneumatic actuators, piezoelectric motors, etc.) and/or passive components (e.g., springs, flexible dampers, tuned mass dampers, damping foam, etc.). The vibration reduction mechanism 400 can be configured to reduce vibration transmission to the sensor module 100 from the vehicle, the license plate, the backing plate 200, and/or any other suitable vibration source or transmitter. In one embodiment, dampers including a flexible material can be arranged as spacers between two or more components (e.g., vehicle, license plate, backing plate 200, sensor module 100, etc.), such that the components contact the dampers rather than contacting each other directly. In a specific example of this embodiment, in which the mounting bracket, license plate, and vehicle are attached to each other by one or more screws, damping washers can be arranged around the screws and between the components (e.g., as shown in FIG. 3). However, the vibration reduction mechanism 400 can be configured in any other suitable manner.

### 4. Hub.

The vehicle sensor system 50 can additionally include a hub 600 (e.g., as shown in FIG. 2), or include any other suitable system. In one example, the vehicle sensor system 50 records video of the vehicle environment, partially processes the video (e.g., dewarps the video, encodes the video, etc.) and sends the video to the hub 600. The hub 600 forwards the video to the user device 500, and can additionally process the video to identify objects or features of interest, generate notifications based on the identified features of interest, and send the notifications to the user device 500. However, the hub and sensor module(s) can be otherwise used.

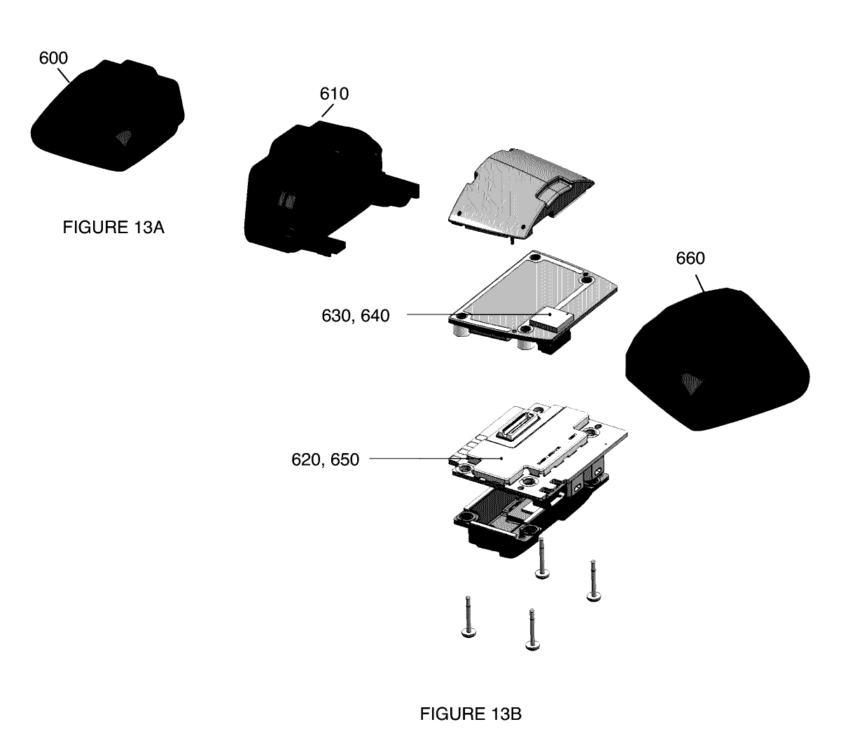

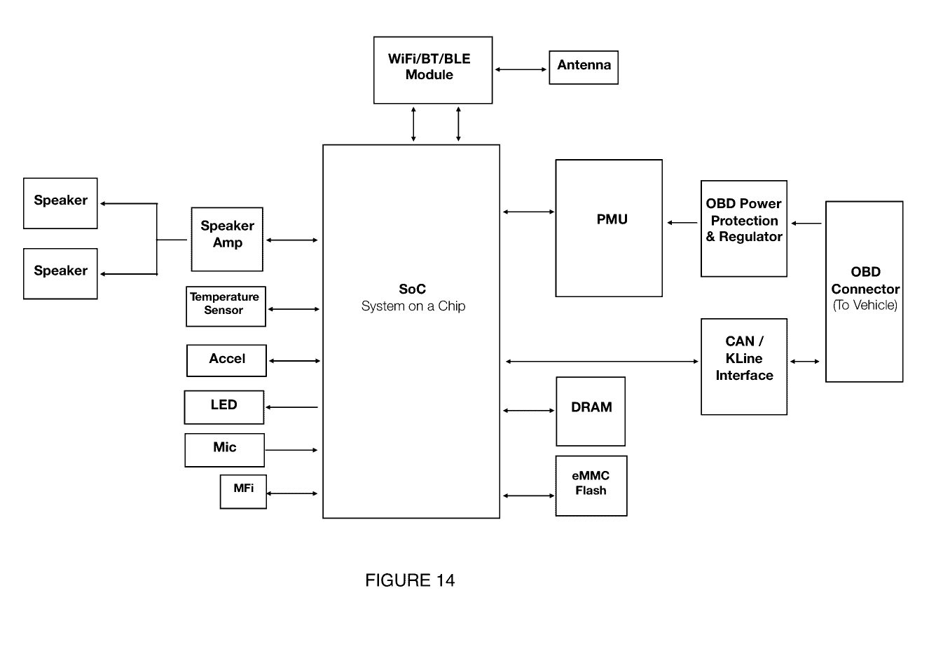

As shown in FIGS. 13A and 13B, the hub 600 functions as a central processing system 620 for the vehicle sensor system 50. The hub 600 can additionally generate a local network, wherein the sensor module 100 and/or user device 500 can be connected to the local network, and the sensor measurements, video, and/or notifications can be communicated through the local network. The hub 600 can additionally function as a vehicle occupancy sensor (e.g., based on hub sensors 630, based on the user device 500 connected to the hub network, etc.), function to identify the user (e.g., based on the user device identifier), or perform any other suitable functionality. The hub 600 is preferably configured to connect to a vehicle connector 610, such as an OBD port (e.g., OBD-II diagnostic connector), but can additionally or alternatively be configured to mount to the vehicle or be otherwise used. The hub 600 can include: a vehicle connector 610, a processing system 620, sensors 630, outputs 640, a communication system 650, and a casing 660.

The vehicle connector 610 of the hub 600 functions to provide vehicle data from a vehicle data bus to the hub 600. The vehicle connector 610 can additionally function to charge the hub 600, identify the vehicle (e.g., determine the make and model), communicate data from the hub 600 to the vehicle data bus, or perform any other suitable functionality. The vehicle connector 610 can be an OBD connector, OBD II connector, CAN bus connector, or be any other suitable connector.

The processing system 620 of the hub 600 functions to control hub operation. The processing system 620 can additionally function to process vehicle sensor system 50 measurements, process vehicle data, control vehicle sensor system operation, control the information displayed on the user device 500, or perform any other suitable functionality. The processing system 620 can be a CPU, GPU, microprocessor, or be any other suitable processing system 620. The processing system 620 can additionally include dedicated hardware that functions to perform specified functions. For example, the processing system 620 can include a decoding circuit (e.g., an H.264 decoder) that functions to decode the video stream, a dewarping circuit that functions to dewarp the video stream, or include any other suitable purpose-built silicon configured to perform a specific function. Alternatively, the specified functions can be performed by software in generic circuitry.

The sensors 630 of the hub 600 function to record measurements indicative of the hub ambient environment, and/or of hub operation. Hub sensors 630 can include cameras, orientation sensors (e.g., accelerometers, gyroscopes, etc.), temperature sensors, pressure sensors, acoustic sensors (e.g., microphones), light sensors (e.g., ambient light sensors), Hall effect sensors, magnetometers, proximity sensors, touch sensors (e.g., resistive, capacitive, etc.), or include any other suitable sensor.

The hub 600 can additionally include a set of outputs 640, which function to provide user feedback. Outputs can include displays, individual lighting elements (e.g., LEDs), speakers, haptic feedback motors, or include any suitable output. The outputs 640 can be operated based on the vehicle sensor system 50 measurements (e.g., sensor module 100 measurements, hub sensor measurements, etc.), the user device 500 measurements, data received from a remote system, or be operated based on any suitable set of information. In one variation, the outputs 640 can be used to notify the user that the sensor module 100 should be removed and recharged.

The communication system 650 of the hub 600 functions to facilitate wireless communication between the sensor module 100, hub 600, and/or user device 500. The communication system 650 can be a transmitter, receiver, transceiver, and/or a local area network generator (e.g., a hotspot). The communication system 650 can include a long range communication module (e.g., Zigbee, Z-wave, WiFi, cellular, etc.), a short range communication module (e.g., Bluetooth, BLE beacon, NFC, RF, IR, etc.), a combination of the above, or include any other suitable module for any other suitable communication protocol. The communication system 650 can include any suitable number of long- or short-range communication modules. In a specific example, the communication system 650 includes a WiFi radio and a BLE radio, both capable of generating local area networks. The hub 600 can be paired with the sensor module 100 or remain unpaired. In one variation, the hub 600 can be pre-paired with the corresponding sensor module 100 (e.g., at the manufacturer site, by the device user, automatically upon recognition of a sensor module 100), and automatically search for the paired sensor module 100 in response to activation. In a specific example, once a hub 600 has been paired with a sensor module 100 and/or a user device 500, unpairing and/or creation of additional pairings can be precluded, or can be conditional upon satisfaction of a security challenge (e.g., owner authentication, manufacturer override, etc.). Alternatively, the paired sensor module 100 can automatically search for the hub 600 in response to activation. Alternatively, the user device 500 can independently connect to the hub 600 and the sensor module 100, and send the connection credentials of one to the other (e.g., send the connection credentials of the hub 600 to the sensor module 100). In a specific example, the hub 600 can include a Wi-Fi radio configured to automatically connect wirelessly to the wireless communication module 152 of the sensor module 100. However, the communication connection between the hub 600 and the sensor module 100 can be otherwise established.

The casing 660 of the hub 600 functions to encapsulate and mechanically protect the hub 600 components. The casing 660 can additionally function as electrical ground for hub 600 electronics, function as an EMI shield, function as a heatsink (e.g. include internal or external fins or other cooling features), or perform any other suitable functionality. Alternatively, the hub 600 electronics can be electrically grounded to the electrical ground of the vehicle connector 610. The casing 660 can be made of metal, plastic, ceramic, or any other suitable material. The casing 660 can additionally include a set of external data connectors, configured to physically connect to the sensor module 100. The external data connectors can include USB connectors, permanent power connectors, Firewire connectors, or include any suitable set of connectors. The casing 660 can additionally include mechanical retention structures (e.g., screw bosses, latches, etc.) that are also electrically-conductive paths (e.g., grounding, power, and/or data paths). These electrically-conductive paths can connect the hub 600 to a vehicle data bus, a vehicle power source, and/or any other suitable electrical component of the vehicle and/or systems attached to the vehicle.

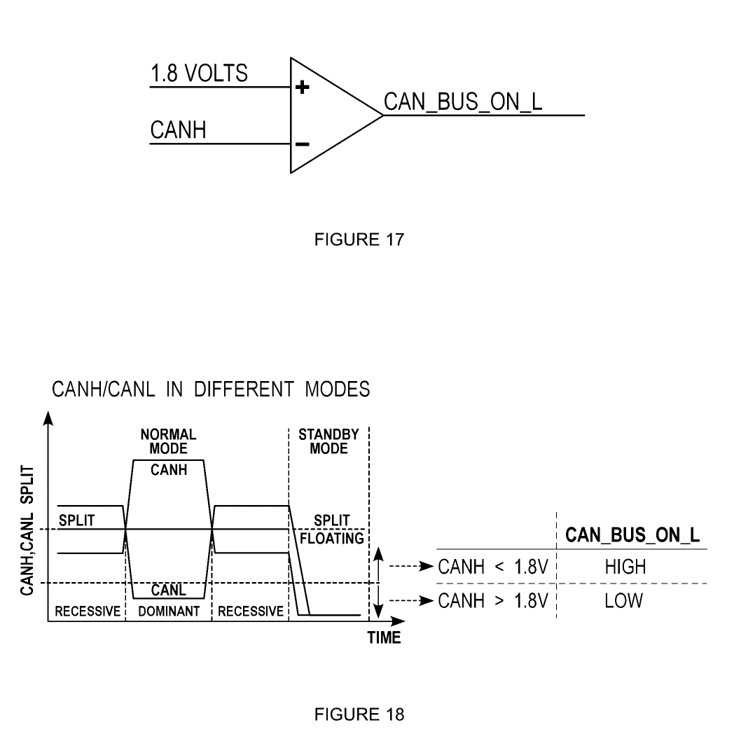

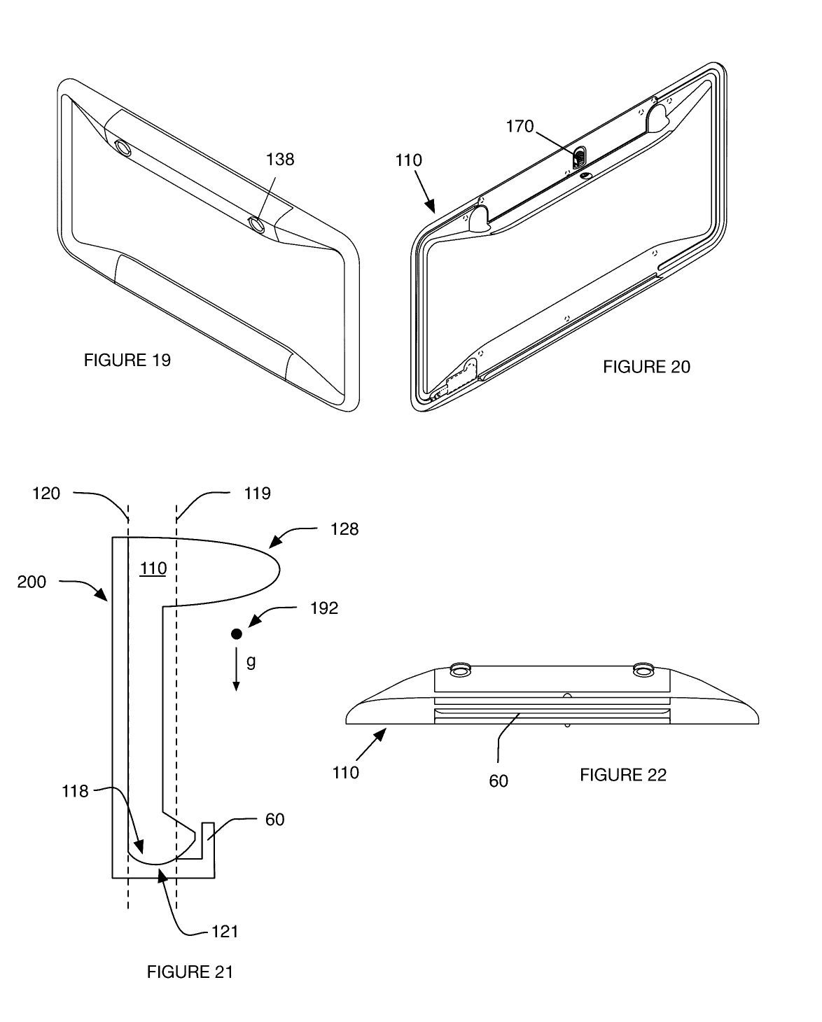

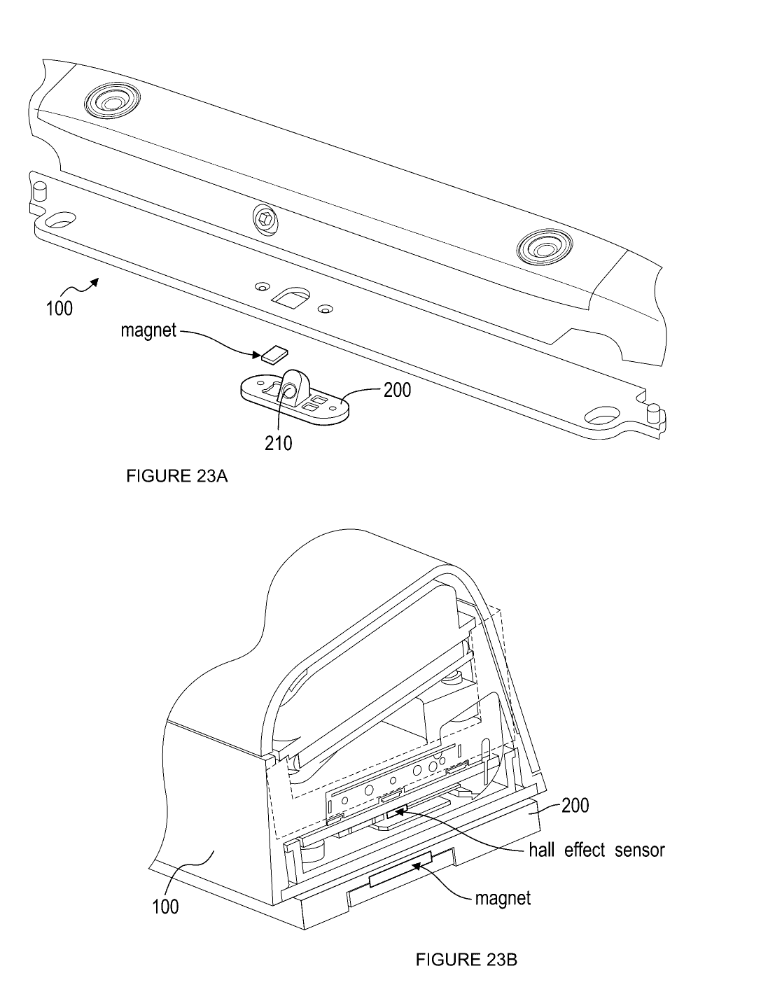

The hub 600 can optionally include a vehicle bus status detector, which functions to detect the status of the vehicle bus. A vehicle bus status detector can be desirable because vehicles that utilize a gateway for the OBD-II port (diagnostics port) will not send CAN traffic (dominant bits) unless the device plugged into the port queries for a PID (e.g., no data traffic occurs unless requested by the hub 600). When the vehicle is off (e.g., parked), the vehicle bus can enter a standby mode to conserve power. In the standby mode, all ECUs on the bus must disable their respective pull ups to allow the bus lines CANH/CANL to power down (e.g., to 0V). The vehicle bus status detector can detect the status of the vehicle, such that the hub 600 can selectively cease ECU querying (wherein querying could wake up the ECU, which could incur extra power draw in the vehicle and drain the car battery). In one variation, the vehicle bus status detector can include a differential comparator input, which detects the voltage difference between CANH and CANL. In a second variation, the vehicle bus status detector can include a single differential comparator configured to detect when the CANH exceeds a threshold voltage (e.g., 1.8V), indicative of bus operation (e.g., the bus not operating in standby mode), example shown in FIG. 17. In response to detection that the CANH exceeds the threshold voltage, the vehicle bus status detector can notify the processing system 620 (examples shown in FIG. 18), which can subsequently query the ECU or perform any other suitable function. In response to the CANH falling below a second threshold voltage (e.g., the same or different from the first threshold), the comparator can release its open drain on the CAN_BUS_ON_L signal, and the vehicle bus status detector output can go high (e.g., to 1.8V or any other suitable voltage) indicating to the processor that the bus is in standby mode. In a third variation, the vehicle bus status detector can be the processor, wherein bus activity is inferred from vehicle activity, which is detected through on-board sensors. However, any other suitable vehicle bus status detector can be used.

### 5. User Device.

The vehicle sensor system 50 can optionally include or be used with one or more user devices. The user device 500 functions as a display for information generated by the vehicle sensor system 50. The user device 500 can additionally generate a local network, wherein the sensor module 100 and/or hub 600 can be connected to the local network, and the sensor measurements, video, and/or notifications can be communicated through the local network. The user device 500 is preferably a user device 500 associated with a user account, wherein the user account is associated with the vehicle sensor system 50, but can alternatively be a user device 500 associated with a secondary user account, or be any other suitable user device 500. The user device 500 can be a vehicle display, a mobile device (e.g., a smartphone, tablet, etc.), or be any other suitable device. The user device 500 preferably includes a display, and can additionally or alternatively include a user input system (e.g., touchscreen, keyboard, mouse, etc.), a set of sensors 140, a communication module, and/or any other suitable system.

Although omitted for conciseness, the preferred embodiments include every combination and permutation of the various system components and the various method processes.

As a person skilled in the art will recognize from the previous detailed description and from the figures and claims, modifications and changes can be made to the preferred embodiments of the invention without departing from the scope of this invention defined in the following claims.

What is claimed is:

1. A vehicle retrofit system for a vehicle having a license plate, the vehicle retrofit system comprising:
a backing plate configured to couple to the vehicle such that the license plate is arranged between the vehicle and the backing plate, the backing plate comprising a first retention mechanism and a groove;
a sensor module comprising:
a housing comprising an exterior and a mating surface, the mating surface removably couplable to the groove;
a sensor within the housing;
a wireless communication module within the housing, the wireless communication module electrically coupled to the sensor;
a battery within the housing, the battery electrically coupled to the wireless communication module;
a solar cell mounted to the housing, the solar cell electrically coupled to the battery;
an electrical connector on the exterior of the housing, the electrical connector electrically coupled to the battery; and
a second retention mechanism removably couplable to the first retention mechanism of the backing plate; and
a bias generating mechanism configured to bias the sensor module away from the backing plate.

2. The system of claim 1, wherein:
the housing defines a frontal plane and a rear plane parallel to the frontal plane;
the mating surface defines a support region, the support region extending between and terminating at the frontal plane and the rear plane; and
the bias generating mechanism comprises a sensor module weight distribution, wherein the sensor module weight distribution comprises a sensor module center of mass distal the rear plane across the frontal plane.

3. The system of claim 3, the housing further comprising a top region opposing the mating surface, the top region containing the sensor, the wireless communication module, and the battery.

4. The system of claim 1, wherein the sensor comprises a camera.

5. The system of claim 4, wherein the camera comprises a fisheye lens and a visible light sensor, and the sensor module further comprises an infrared camera within the housing, the infrared camera electrically coupled to the wireless communication module.

6. The system of claim 1, wherein the wireless communication module comprises a high-power radio and a low-power radio.

7. The system of claim 1, wherein the first retention mechanism comprises a threaded hole and the second retention mechanism comprises a security screw with threading complementary to the threaded hole.

8. A vehicle retrofit system for a vehicle having a license plate, the vehicle retrofit system comprising:
a backing plate configured to couple to the vehicle such that the license plate is arranged between the vehicle and the backing plate, the backing plate comprising a first retention mechanism; and
a sensor module comprising:
a housing comprising an exterior and a first arm;
a camera within the first arm of the housing;
a wireless communication module within the first arm of the housing, the wireless communication module electrically coupled to the camera;
a battery within the first arm of the housing, the battery electrically coupled to the wireless communication module;
a solar cell within the housing, the solar cell electrically coupled to the battery;
an electrical connector on the exterior of the housing, the electrical connector electrically coupled to the battery; and
a second retention mechanism removably couplable to the first retention mechanism of the backing plate.

9. The system of claim 8, wherein:
the backing plate further comprises a backing plate mating surface;
the housing further comprises a second arm opposing the first arm, the second arm comprising a sensor module mating surface, the sensor module mating surface removably couplable to the backing plate mating surface, the sensor module mating surface defining a support region;
the housing defines a frontal plane and a rear plane;
the support region extends between and terminates at the frontal plane and the rear plane; and
the sensor module comprises a sensor module weight distribution, the sensor module weight distribution comprising a sensor module center of mass distal the rear plane across the frontal plane.

10. The system of claim 9, wherein the first arm forms a handle.

11. The system of claim 8, wherein the first arm of the housing comprises electromagnetic shielding.

12. The system of claim 8, wherein the first arm of the housing comprises a water-resistant enclosure surrounding the camera, the wireless communication module, and the battery.

13. The system of claim 8, wherein the system further comprises a hub wirelessly paired to the sensor module.

14. The system of claim 13, wherein the hub comprises an OBD-II diagnostic connector and a Wi-Fi radio configured to automatically connect wirelessly to the wireless communication module of the sensor module.

15. The system of claim 8, wherein the first retention mechanism comprises a threaded hole and the second retention mechanism comprises a security screw with threading complementary to the threaded hole.

16. The system of claim 8, wherein the camera comprises a fisheye lens and a visible light sensor, and the sensor module further comprises an infrared camera within the first arm of the housing, the infrared camera electrically coupled to the wireless communication module.

17. The system of claim 8, wherein:
the sensor module further comprises an accelerometer mechanically coupled to the housing, the accelerometer configured to sample and transmit a set of acceleration data; and
the system further comprises a processor configured to stabilize of the set of image data based on the set of acceleration data.

18. The system of claim 8, wherein the electrical connector comprises a power and data connector configured to transmit power and data.

19. The system of claim 8, the housing further comprising a third arm and a fourth arm, the first arm and the second arm each having a first end and a second end, wherein the third arm is connected to the first end of the first arm and the first end of the second arm and the fourth arm is connected to the second end of the first arm and the second end of the second arm, wherein the housing defines a license plate frame.

20. The system of claim 19, wherein the solar cell is within the second arm and the solar cell is electrically coupled to the battery by a wire having a first end electrically coupled to the solar cell and a second end electrically coupled to the battery, wherein the wire extends through the third arm.
